(19) United States
(12) Patent Application Publication
(10) Pub. No.: US 2025/0138286 A1
(43) Pub. Date: May 1, 2025

(54) OPTICAL IMAGING SYSTEM

(71) Applicant: Samsung Electro-Mechanics Co., Ltd., Suwon-si (KR)

(72) Inventors: Yong Joo JO, Suwon-si (KR); Tae Yeon LIM, Suwon-si (KR); Byung Hyun KIM, Suwon-si (KR)

(73) Assignee: Samsung Electro-Mechanics Co., Ltd., Suwon-si (KR)

(21) Appl. No.: 18/922,858

(22) Filed: Oct. 22, 2024

(30) Foreign Application Priority Data
Oct. 25, 2023 (KR) 10-2023-0144144

(51) Int. Cl. G02B 13/00; G02B 15/14

(52) U.S. Cl. CPC G02B 13/0065; G02B 13/0045; G02B 15/1421

(57) ABSTRACT

An optical imaging system includes a first lens group including a reflective member and one or two lenses disposed in front of the reflective member; and a second lens group disposed behind the reflective member and including a plurality of lenses. The one or two lenses included in the first lens group have a positive refractive power overall, an image-side surface of a lens disposed closest to the reflective member among the one or two lenses included in the first lens group is concave, the reflective member includes an incident surface, a reflection surface, and an exit surface, and 0.25≤D12P/DR≤1.0 is satisfied, where D12P is a distance on an optical axis from the image-side surface of the lens disposed closest to the reflective member to the incident surface, and DR is a distance on the optical axis from the incident surface to the reflection surface.

### CROSS-REFERENCE TO RELATED APPLICATIONS

This application claims the benefit under 35 USC 119 (a) of Korean Patent Application No. 10-2023-0144144 filed on Oct. 25, 2023, in the Korean Intellectual Property Office, the entire disclosure of which is incorporated herein by reference for all purposes.

### BACKGROUND

### 1. Field

The present disclosure relates to an optical imaging system.

### 2. Description of Related Art

Recent portable terminals have been equipped with cameras that include an optical imaging system including a plurality of lenses to enable video calls and image capturing.

In addition, as the functionality of cameras in portable terminals gradually increases, demand for cameras for portable terminals having a high resolution is increasing.

In addition, as portable terminals are gradually decreasing in size, cameras for portable terminals are also needed to be slimmer. Accordingly, the development of an optical imaging system that is slim yet capable of implementing a high resolution is desired.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group including a reflective member and one or two lenses disposed in front of the reflective member; and a second lens group disposed behind the reflective member and including a plurality of lenses, wherein the one or two lenses included in the first lens group have a positive refractive power overall, an image-side surface of a lens disposed closest to the reflective member among the one or two lenses of the first lens group is concave, the reflective member includes an incident surface, a reflection surface, and an exit surface, and 0.25≤D12P/DR≤1.0 is satisfied, where D12P is a distance on an optical axis of the optical imaging system from the image-side surface of the lens disposed closest to the reflective member among the one or two lenses of the first lens group to the incident surface of the reflective member, and DR is a distance on the optical axis from the incident surface of the reflective member to the reflection surface of the reflective member.

The reflective member may be configured to be rotatable about two axes perpendicular to each other.

The one or two lenses included in the first lens group may include a first lens having an object-side surface that is convex in a paraxial region thereof, and an image-side surface that is concave in a paraxial region thereof, and an effective diameter of the object-side surface of the first lens and an effective diameter of the image-side surface of the first lens may be greater than a minor axis length of the incident surface of the reflective member.

0.6<RG1_S1/RG1_S2<0.8 may be satisfied, where RG1_S1 is a radius of curvature of the object-side surface of the first lens, and RG1_S2 is a radius of curvature of the image-side surface of the first lens.

1.3<fG1/fG2<3 may be satisfied, where fG1 is a focal length of the first lens group, and fG2 is a focal length of the second lens group.

0.35≤DR/L2S1_ED≤0.65 may be satisfied, where L2S1_ED is an effective diameter of an object-side surface of a lens disposed closest to the reflective member among the plurality of lenses included in the second lens group.

0.65≤D11P/DR≤1.55 may be satisfied, where D11P is a distance on the optical axis from an object-side surface of a lens disposed closest to an object side of the optical imaging system among the one or two lenses included in the first lens group to the incident surface of the reflective member.

−0.25≤(RG1_S1−RG1_S2)/(RG1_S1+RG1_S2)<0 may be satisfied, where RG1_S1 is a radius of curvature of an object-side surface of a lens disposed closest to an object side of the optical imaging system among the one or two lenses included in the first lens group, and RG1_S2 is a radius of curvature of the image-side surface of the lens disposed closest to the reflective member among the one or two lenses included in the first lens group.

−0.6≤RG2_S1/fG2≤2.1 may be satisfied, where RG2_S1 is a radius of curvature of an object-side surface of a lens disposed closest to the reflective member among the plurality of lenses included in the second lens group, and fG2 is a focal length of the second lens group.

0.7≤DP21/DR≤1.6 may be satisfied, where DP21 is a distance on the optical axis from the exit surface of the reflective member to an object-side surface of a lens disposed closest to the reflective member among the plurality of lenses included in the second lens group.

0<D12P/L<0.1, 0<DP21/L≤0.2, and 0.3<D12P/DP21<0.6 may be satisfied, where L is a sum of a distance on the optical axis from an object-side surface of a lens disposed closest to an object side of the optical imaging system among the one or two lenses included in the first lens group to the reflection surface of the reflective member, and a distance on the optical axis from the reflection surface of the reflective member to an imaging plane of the optical imaging system.

1.1≤fG1/L≤1.9 may be satisfied, where fG1 is a focal length of the first lens group, and L is a sum of a distance on the optical axis from an object-side surface of a lens disposed closest to an object side of the optical imaging system among the one or two lenses included in the first lens group to the reflection surface of the reflective member, and a distance on the optical axis from the reflection surface of the reflective member to an imaging plane of the optical imaging system.

0.1≤Lf/Lr≤0.4 may be satisfied, where Lf is a distance on the optical axis from an object-side surface of a lens disposed closest to an object side of the optical imaging system among the one or two lenses included in the first lens group to the reflection surface of the reflective member, and Lr is a distance on the optical axis from the reflection surface of the reflective member to an imaging plane of the optical imaging system.

0.25<G1_MED/Lr<0.42 and 0.7<G2_MED/Lf<1.4 may be satisfied, where G1_MED is a maximum effective diameter of the one or two lenses included in the first lens group, and G2_MED is a maximum effective diameter of the plurality of lenses included in the second lens group.

0.35<f/fG1≤0.5 may be satisfied, where f is a total focal length of the optical imaging system, and fG1 is a focal length of the first lens group.

0.6<f/fG2≤1.1 may be satisfied, where f is a total focal length of the optical imaging system, and fG2 is a focal length of the second lens group.

A lens disposed closest to the reflective member among the plurality of lenses of the second lens group may have a positive refractive power.

At least three lenses among the plurality of lenses of the second lens group may have a refractive index greater than 1.6.

In another general aspect, an optical imaging system includes a first lens group including a reflective member and one or two lenses disposed in front of the reflective member; and a second lens group disposed behind the reflective member and including a plurality of lenses, wherein the one or two lenses of the first lens group have a positive refractive power overall, an image-side surface of a lens disposed closest to the reflective member among the one or two lenses of the first lens group is concave, the reflective member includes an incident surface, a reflection surface, and an exit surface, and 0.7≤DP21/DR≤1.6 is satisfied, where DP21 is a distance on an optical axis of the optical imaging system from the exit surface of the reflective member to an object-side surface of a lens disposed closest to the reflective member among the lenses of the second lens group, and DR is a distance on the optical axis from the incident surface of the reflective member to the reflection surface of the reflective member.

There may be a total of one lens having a refractive power in the first lens group, and a total of five or six lenses having a refractive power in the second lens group.

The one lens of the first lens group may be a first lens having a positive refractive power, a convex object-side surface in a paraxial region thereof, and a concave image-side surface in a paraxial region thereof, and the five or six lenses of the second lens group may include a second lens closest to the reflective member among the five or six lenses of the second lens group and having a positive refractive power.

There may be a total of five lenses having a refractive power in the second lens group, and the five lenses may include the second lens having the positive refractive power, a third lens having a negative refractive power, a fourth lens having a positive refractive power or a negative refractive power, a fifth lens having a positive refractive power, and a sixth lens having a positive refractive power or a negative refractive power.

The plurality of lenses of the second lens group may be configured so that lenses among the plurality of lenses disposed adjacent to each other have different refractive indexes and different Abbe numbers.

In another general aspect, an optical imaging system includes a first lens group including a reflective member and one or two lenses disposed in front of the reflective member; and a second lens group disposed behind the reflective member and including a plurality of lenses, wherein the one or two lenses of the first lens group have a positive refractive power overall, an image-side surface of a lens disposed closest to the reflective member among the one or two lenses of the first lens group is concave, the reflective member includes an incident surface, a reflection surface, and an exit surface, and 0.3<D12P/DP21<0.6 is satisfied, where D12P is a distance on an optical axis of the optical imaging system from the image-side surface of the lens disposed closest to the reflective member among the one or two lenses of the first lens group to the incident surface of the reflective member, and DP21 is a distance on the optical axis from the exit surface of the reflective member to an object-side surface of a lens disposed closest to the reflective member among the plurality of lenses of the second lens group.

There may be a total of one lens having a refractive power in the first lens group, and a total of five or six lenses having a refractive power in the second lens group.

The one lens of the first lens group may be a first lens having a positive refractive power, a convex object-side surface in a paraxial region thereof, and a concave image-side surface in a paraxial region thereof, and the five or six lenses of the second lens group may include a second lens closest to the reflective member among the five or six lenses of the second lens group and having a positive refractive power.

There may be a total of six lenses having a refractive power in the second lens group, and the six lenses may include the second lens having the positive refractive power, a third lens having a positive refractive power, a fourth lens having a negative refractive power, a fifth lens having a negative refractive power, a sixth lens having a positive refractive power, and a seventh lens having a positive refractive power or a negative refractive power.

The first lens group may be disposed at a fixed position on the optical axis, and the second lens groups may be configured to be movable along the optical axis relative to the first lens group to adjust a focus of the optical imaging system.

Other features and aspects will be apparent from the following detailed description, the drawings, and the claims.

### BRIEF DESCRIPTION OF DRAWINGS

FIG. 1A is a configuration diagram of an optical imaging system according to a first embodiment when shooting an object at an infinite distance.

FIG. 1B is a configuration diagram of the optical imaging system according to the first embodiment when shooting an object at a near-focus position, i.e., a nearest position of an object at which the optical imaging system can focus an image of the object.

FIG. 2A is a configuration diagram of an optical imaging system according to a second embodiment when shooting an object at an infinite distance.

FIG. 2B is a configuration diagram of the optical imaging system according to the second embodiment when shooting an object at a near-focus position, i.e., a nearest position of an object at which the optical imaging system can focus an image of the object.

FIG. 3A is a configuration diagram of an optical imaging system according to a third embodiment when shooting an object at an infinite distance.

FIG. 3B is a configuration diagram of the optical imaging system according to the third embodiment when shooting an object at a near-focus position, i.e., a nearest position of an object at which the optical imaging system can focus an image of the object.

FIG. 4A is a configuration diagram of an optical imaging system according to a fourth embodiment when shooting an object at an infinite distance.

FIG. 4B is a configuration diagram of the optical imaging system according to the fourth embodiment when shooting an object at a near-focus position, i.e., a nearest position of an object at which the optical imaging system can focus an image of the object.

FIG. 5A is a configuration diagram of an optical imaging system according to a fifth embodiment when shooting an object at an infinite distance.

FIG. 5B is a configuration diagram of the optical imaging system according to the fifth embodiment when shooting an object at a near-focus position, i.e., a nearest position of an object at which the optical imaging system can focus an image of the object.

FIG. 6A is a configuration diagram of an optical imaging system according to a sixth embodiment when shooting an object at an infinite distance.

FIG. 6B is a configuration diagram of the optical imaging system according to the sixth embodiment when shooting an object at a near-focus position, i.e., a nearest position of an object at which the optical imaging system can focus an image of the object.

FIG. 7A is a configuration diagram of an optical imaging system according to a seventh embodiment when shooting an object at an infinite distance.

FIG. 7B is a configuration diagram of the optical imaging system according to the seventh embodiment when shooting an object at a near-focus position, i.e., a nearest position of an object at which the optical imaging system can focus an image of the object.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

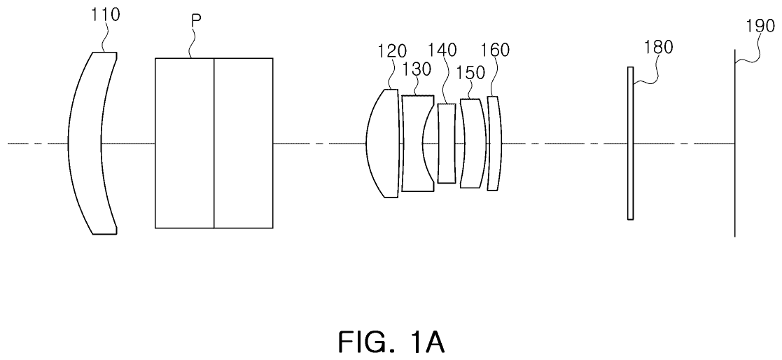

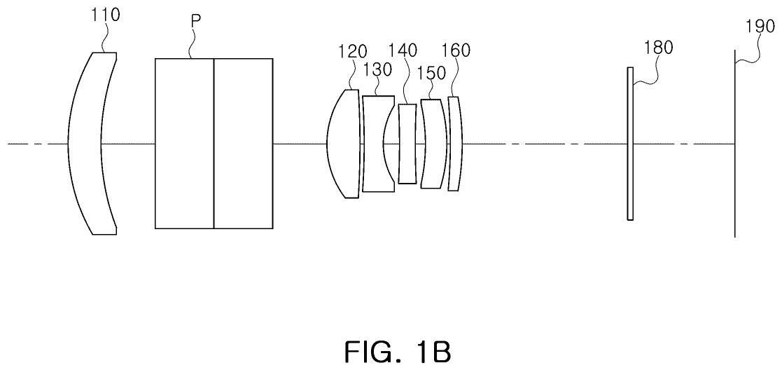

In the configuration diagrams in FIGS. 1A to 7B, the thicknesses, sizes, and shapes of the lenses may be somewhat exaggerated for illustration purposes. In addition, the spherical or aspherical shapes illustrated in the configuration diagrams are merely examples and are not limited to these shapes.

An optical imaging system according to an embodiment may be mounted in a portable electronic device. For example, the optical imaging system may be a component of a camera module mounted in a portable electronic device. Portable electronic devices may be portable electronic devices such as mobile communication terminals, smartphones, and tablet PCs, but are not limited thereto.

In this specification, the first lens (or frontmost lens) refers to the lens closest to the object side of an optical imaging system, and the last lens (or rearmost lens) refers to the lens closest to the imaging plane (or image sensor) of the optical imaging system.

In this specification, the values for the radiuses of curvature, thicknesses, distances, focal lengths of the lenses are all expressed in mm, and the view angle is expressed in degrees.

In addition, in the description of a shape of each lens, a statement that a surface of a lens is convex indicates that the surface is convex in a paraxial region of the surface, and a statement that a surface of a lens is concave indicates that the surface is concave in a paraxial region of the surface.

Accordingly, even if a surface of a lens is described as convex, an edge portion of the surface may be concave. Similarly, even if a surface of a lens is described as concave, an edge portion of the surface may be convex.

A paraxial region of a lens surface is a central portion of the lens surface surrounding the optical axis of the lens surface in which light rays incident to the lens surface make a small angle θ to the optical axis, and the approximations sin θ≈θ, tan θ ≈θ, and cos θ ≈1 are valid.

An imaging plane may refer to a virtual plane on which a focus is formed by an optical imaging system. Alternatively, the imaging plane may refer to one surface of the image sensor receiving light through the optical imaging system.

An optical imaging system according to an embodiment includes a plurality of lens groups. As an example, the optical imaging system may include a first lens group and a second lens group.

The first lens group and the second lens group each include one or more lenses. For example, the first lens group may include one or two lenses, and the second lens group may include four, five, or six lenses.

In an embodiment, the optical imaging system includes a first lens, a second lens, a third lens, a fourth lens, and a fifth lens sequentially disposed in ascending numerical order from the object side of the optical imaging system toward the imaging plane of the optical imaging system. In this case, the first lens group includes the first lens, and the second lens group includes the second to fifth lenses.

In an embodiment, the optical imaging system includes a first lens, a second lens, a third lens, a fourth lens, a fifth lens, and a sixth lens sequentially disposed in ascending numerical order from the object side of the optical imaging system toward the imaging plane of the optical imaging system. In this case, the first lens group includes the first lens, and the second lens group includes the second to sixth lenses.

In an embodiment, the optical imaging system includes a first lens, a second lens, a third lens, a fourth lens, a fifth lens, a sixth lens, and a seventh lens sequentially disposed in ascending numerical order from the object side of the optical imaging system toward the imaging plane of the optical imaging system. In this case, the first lens group includes the first lens, and the second lens group includes the second to seventh lenses.

The optical imaging system according to an embodiment may further include a reflective member having a reflection surface that changes the optical path. As an example, the reflective member may be a mirror or a prism.

For example, when the reflective member is a prism, the reflective member may be in the form of a rectangular parallelepiped or cube divided in two diagonally. The reflective member may include an incident surface, a reflection surface, and an exit surface. The reflective member includes three quadrangular-shaped faces and two triangular-shaped faces. For example, the incident surface, reflection surface, and exit surface of the reflective member are each quadrangular-shaped, and both sides of the reflective member are approximately triangular-shaped.

In an embodiment, the reflective member may be disposed in front of the second lens group. For example, the reflective member may be disposed between the first lens group and the second lens group.

A first lens group may be disposed in front of the reflective member, and a second lens group may be disposed behind the reflective member. The optical axis of the first lens group and the optical axis of the second lens group may be perpendicular to each other, and may be portions of an optical axis of the optical imaging system.

Depending on an embodiment, a reflective member may be included in the first lens group. In this case, the reflective member may be disposed behind one or two lenses included in the first lens group.

For example, when the first lens group includes one lens (for example, the first lens), the reflective member is disposed between the first lens of the first lens group and the second lens of the second lens group.

By bending the optical path through the reflective member, a long optical path may be formed in a relatively narrow space.

Therefore, the optical imaging system may be miniaturized and have a long focal length.

The optical imaging system according to an embodiment has characteristics of a telephoto lens having a relatively narrow angle of view and a relatively long focal length.

Additionally, the optical imaging system may further include an image sensor for converting an image of an object incident on a surface of the image sensor into an electrical signal.

Additionally, the optical imaging system may further include an infrared blocking filter (hereinafter referred to as a filter) to block infrared rays in the light incident through the optical imaging system. The filter may be disposed between the rearmost lens of the optical imaging system and the image sensor.

Additionally, the optical imaging system may further include an aperture to limit the amount of light. In an embodiment, the aperture may be disposed between the third lens and the fourth lens. In an embodiment, the aperture may be disposed between the fourth lens and the fifth lens. In an embodiment, the aperture may be disposed between the reflective member and the second lens.

In an embodiment, the first lens group may include a first lens, and the second lens group may include a second lens, a third lens, a fourth lens, and a fifth lens.

In an embodiment, the first lens group may include a first lens, and the second lens group may include a second lens, a third lens, a fourth lens, a fifth lens, and a sixth lens.

In an embodiment, the first lens group may include a first lens, and the second lens group may include a second lens, a third lens, a fourth lens, a fifth lens, a sixth lens, and a seventh lens.

In an embodiment, the plurality of lenses may be disposed to be spaced apart from each other in the optical axis direction.

In an embodiment, some lenses among the plurality of lenses may be configured as cemented lenses. For example, the third lens and the fourth lens may be a cemented lens. For example, the image-side surface of the third lens and the object-side surface of the fourth lens may be bonded to each other to form a cemented lens.

The sixth lens and the seventh lens may be a cemented lens. For example, the image-side surface of the sixth lens and the object-side surface of the seventh lens may be bonded to each other to form a cemented lens.

Either one or both of the first lens group and the second lens group may be moved to adjust the focus of the optical imaging system.

For example, the distance between the first lens group and the second lens group may be variable. For example, the first lens group may be fixedly disposed, and the second lens group may be configured to be movable in the optical axis direction. As the second lens group moves away from the image side toward the object side, the optical imaging system may capture an image of an object at distances between infinity (at a position of the second lens group closest to the image side) and a close distance (a near-focus distance) (for example, 300 mm) (at a position of the second lens group closest to the object side).

Since the first lens group is located at the front of the optical imaging system, implementing water and dust resistance may be facilitated by fixing the position of the first lens group.

The first lens group has a positive refractive power overall and includes at least one lens having a meniscus shape convex toward the object.

In an embodiment, the first lens group includes one lens (for example, a first lens). The first lens is disposed in front of the reflective member.

The first lens may have a positive refractive power and have a meniscus shape convex toward the object. The radius of curvature of the object-side surface of the first lens may be smaller than the radius of curvature of the image-side surface of the first lens.

The effective diameter of the object-side surface and the effective diameter of the image-side surface of the first lens may each be larger than the minor axis length of the incident surface of the reflective member.

The first lens may be made of a plastic material, and may have the object-side surface and the image-side surface each being aspherical.

In an embodiment (not shown in the drawings), the first lens group includes two lenses (for example, a 1-1 lens and a 1-2 lens). For example, when the first lens group includes two lenses, the composite focal length of the two lenses may have a positive refractive power. Additionally, the two lenses may be bonded together. For example, the image-side surface of the 1-1 lens and the object-side surface of the 1-2 lens may be bonded to each other to form a cemented lens.

The second lens group includes a plurality of lenses and has a positive refractive power overall. Among the plurality of lenses in the second lens group, at least three lenses have a refractive index exceeding 1.6. Among the plurality of lenses in the second lens group, a lens disposed closest to the reflective member has a positive refractive power.

In an embodiment, the second lens group includes a second lens, a third lens, a fourth lens, and a fifth lens. The second lens may have a positive refractive power, the third lens may have a positive refractive power, the fourth lens may have a negative refractive power, and the fifth lens may have a positive refractive power.

The second to fifth lenses may be configured so that lenses disposed adjacent to each other have different refractive indexes and different Abbe numbers. For example, the Abbe number of the second lens is larger than the Abbe number of the third lens, the Abbe number of the third lens is smaller than the Abbe number of the fourth lens, and the Abbe number of the fourth lens is smaller than the Abbe number of the fifth lens.

In an embodiment, the second lens group includes a second lens, a third lens, a fourth lens, a fifth lens, and a sixth lens. The second lens may have a positive refractive power, the third lens may have a negative refractive power, the fourth lens may have a positive refractive power or a negative refractive power, the fifth lens may have a positive refractive power, and the sixth lens may have a positive refractive power or a negative refractive power.

The second to sixth lenses may be configured so that lenses disposed adjacent to each other have different refractive indexes and different Abbe numbers. For example, the Abbe number of the second lens is greater than the Abbe number of the third lens, the Abbe number of the third lens is smaller than the Abbe number of the fourth lens, the Abbe number of the fourth lens is greater than the Abbe number of the fifth lens, and the Abbe number of the fifth lens is smaller than the Abbe number of the sixth lens.

In an embodiment, the second lens group includes a second lens, a third lens, a fourth lens, a fifth lens, a sixth lens, and a seventh lens. The second lens may have a positive refractive power, the third lens may have a positive refractive power, the fourth lens may have a negative refractive power, the fifth lens may have a negative refractive power, the sixth lens may have a positive refractive power, and the seventh lens may have a positive refractive power or a negative refractive power.

The second to seventh lenses may be configured so that lenses disposed adjacent to each other have different refractive indexes and different Abbe numbers. For example, the Abbe number of the second lens is smaller than the Abbe number of the third lens, the Abbe number of the third lens is larger than the Abbe number of the fourth lens, the Abbe number of the fourth lens is smaller than the Abbe number of the fifth lens, the Abbe number of the fifth lens is smaller than the Abbe number of the sixth lens, and the Abbe number of the sixth lens is larger than the Abbe number of the seventh lens.

The reflective member is disposed in front of the second lens group. The reflective member may be rotated around two axes to compensate for shaking during filming.

For example, when shaking occurs due to factors such as the user's hand tremor or the other disturbance when shooting an image or a video, the shaking may be compensated by rotating the reflective member around the two axes in response to the shaking.

Because the reflective member has a relatively lighter weight than the optical imaging system, shaking may be easily compensated with a smaller driving force.

Some or all of the plurality of lenses may have an aspherical surface.

In an embodiment, one or more lenses included in the first lens group may have an object-side surface and an image-side surface that are aspherical.

In an embodiment, one or more lenses among the plurality of lenses included in the second lens group may have an object-side surface and an image-side surface that are aspherical.

The aspherical surface of the lens is expressed by Equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} \qquad ( 1 )$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to E are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

The optical imaging system according to an embodiment may satisfy any one or any combination of any two or more of the following Conditional Expressions 1 to 21:

$$0.25 \leq D 12 P / DR \leq 1. \qquad ( Conditional Expression 1 )$$

$$0.35 \leq DR / L2S1\_ED \leq 0.65 \qquad ( Conditional Expression 2 )$$

$$0.65 \leq D 11 P / DR \leq 1.55 \qquad ( Conditional Expression 3 )$$

$$- 0.25 \leq ( RG1\_S1 - RG1\_S2 ) / ( RG1\_S1 + RG1\_S2 ) < 0 \qquad ( Conditional Expression 4 )$$

$$- 0.6 \leq RG2\_S1 / fG 2 \leq 2.1 \qquad ( Conditional Expression 5 )$$

$$0.7 \leq DP 21 / DR \leq 1.6 \qquad ( Conditional Expression 6 )$$

$$1.1 \leq fG 1 / L \leq 1.9 \qquad ( Conditional Expression 7 )$$

$$0.1 \leq Lf / Lr \leq 0.4 \qquad ( Conditional Expression 8 )$$

$$0 < D 12 P / L < 0.1 \qquad ( Conditional Expression 9 )$$

$$0 < DP 21 / L \leq 0.2 \qquad ( Conditional Expression 10 )$$

$$1 < G1\_MED / PED < 1.3 \qquad ( Conditional Expression 11 )$$

$$0.6 < RG1\_S1 / RG1\_S2 < 0.8 \qquad ( Conditional Expression 12 )$$

$$0.18 < D 2 / L < 0.45 \qquad ( Conditional Expression 13 )$$

$$0.35 < f / fG 1 \leq 0.5 \qquad ( Conditional Expression 14 )$$

$$0.6 < f / fG 2 \leq 1.1 \qquad ( Conditional Expression 15 )$$

$$1.3 < fG 1 / fG 2 < 3 \qquad ( Conditional Expression 16 )$$

$$0.3 < D 12 P / DP 21 < 0.6 \qquad ( Conditional Expression 17 )$$

$$0.7 < G2\_MED / Lf < 1.4 \qquad ( Conditional Expression 18 )$$

$$0.25 < G1\_MED / Lr < 0.42 \qquad ( Conditional Expression 19 )$$

$$5.3 < Fno \times ( fG 1 / f ) < 7.7 \qquad ( Conditional Expression 20 )$$

$$0.35 ( ° / mm ) < FOV / Lr < 0.7 ( ° / mm ) \qquad ( Conditional Expression 21 )$$

In an embodiment, the optical imaging system may satisfy 0.25≤D12P/DR≤1.0 (Conditional Expression 1). In this case, D12P is the distance on the optical axis between the first lens group and the incident surface of the reflective member. In detail, D12P is the distance on the optical axis from the image-side surface of the lens (for example, the image-side surface of the first lens) disposed closest to the reflective member among one or two lenses included in the first lens group to the incident surface of the reflective member. DR is the distance on the optical axis from the incident surface of the reflective member to the reflection surface of the reflective member.

In this embodiment, one or two lenses included in the first lens group are disposed closer to the object side than the reflective member. Therefore, the first lens group and the reflective member may be prevented from interfering with each other, and the optical imaging system may be miniaturized.

In an embodiment, the optical imaging system may satisfy 0.35≤DR/L2S1_ED≤0.65 (Conditional Expression 2). In this case, L2S1_ED is the effective diameter of the object-side surface (for example, the object-side surface of the second lens) of the lens disposed closest to the reflective member among the lenses included in the second lens group. Therefore, the optical imaging system may be miniaturized.

In an embodiment, the optical imaging system may satisfy 0.65≤D11P/DR≤1.55 (Conditional Expression 3). In this case, D11P is the distance on the optical axis from the object-side surface of the lens (for example, the object-side surface of the first lens) disposed closest to the object side among one or two lenses included in the first lens group to the incident surface of the reflective member. Therefore, the optical imaging system may be prevented from becoming too thick in the optical axis direction of the first lens group. Additionally, when the reflective member is rotated for shake correction, the first lens group and the reflective member may be prevented from interfering with each other.

In an embodiment, the optical imaging system may satisfy −0.25≤(RG1_S1-RG1_S2)/(RG1_S1+RG1_S2)<0 (Conditional Expression 4). In this case, RG1_S1 is the radius of curvature of the object-side surface of the lens (for example, the object-side surface of the first lens) disposed closest to the object side among one or two lenses included in the first lens group, and RG1_S2 is the radius of curvature of the image-side surface of the lens (for example, the image-side surface of the first lens) disposed closest to the reflective member among the one or two lenses included in the first lens group. Accordingly, spherical aberration occurring in the first lens group may be significantly reduced. In addition, by appropriately adjusting the focal length of the one or two lenses included in the first lens group, occurrence of aberrations may be significantly reduced while maintaining a sufficient telephoto performance.

In an embodiment, the optical imaging system may satisfy −0.6≤RG2_S1/fG2≤2.1 (Conditional Expression 5). In this case, RG2_S1 is the radius of curvature of the object-side surface of the lens (for example, the object-side surface of the second lens) disposed closest to the reflective member among the lenses included in the second lens group, and fG2 is the focal length of the second lens group. Therefore, by optimizing the refractive power of the second lens group, spherical aberration may be reduced and a resolution may be improved.

In an embodiment, the optical imaging system may satisfy 0.7≤DP21/DR≤1.6 (Conditional Expression 6). In this case, DP21 is the distance on the optical axis from the exit surface of the reflective member to the object-side surface of the lens (for example, the object-side surface of the second lens) disposed closest to the reflective member among the lenses included in the second lens group. When the second lens group moves for focus adjustment, it is necessary to secure an appropriate space between the reflective member and the second lens group. Therefore, by appropriately adjusting the size of the reflective member and the distance on the optical axis between the reflective member and the second lens group, the optical imaging system may be miniaturized and the space needed for shake correction and focus adjustment may be secured.

In an embodiment, the optical imaging system may satisfy 1.1≤fG1/L≤1.9 (Conditional Expression 7). In this case, fG1 is the focal length of the first lens group, and L is the sum of the distance on the optical axis from the object-side surface of the lens (for example, the object-side surface of the first lens) disposed closest to the object-side among one or two lenses included in the first lens group to the reflection surface of the reflective member, and the distance on the optical axis from the reflection surface of the reflective member to the imaging plane. Therefore, the optical imaging system may be miniaturized and the occurrence of aberrations may be significantly reduced.

In an embodiment, the optical imaging system may satisfy 0.1≤Lf/Lr≤0.4 (Conditional Expression 8). In this case, Lf is the distance on the optical axis from the object-side surface of the lens (for example, the object-side surface of the first lens) disposed closest to the object side among one or two lenses included in the first lens group to the reflection surface of the reflective member, and Lr is the distance on the optical axis from the reflection surface of the reflective member to the imaging plane. Therefore, the optical imaging system may be miniaturized.

In an embodiment, the optical imaging system may satisfy 0<D12P/L<0.1 (Conditional Expression 9). Therefore, the optical imaging system may be miniaturized by appropriately adjusting the distance on the optical axis between one or two lenses included in the first lens group and the reflective member.

In an embodiment, the optical imaging system may satisfy 0<DP21/L≤0.2 (Conditional Expression 10). Therefore, the optical imaging system may be miniaturized by appropriately adjusting the distance on the optical axis between the reflective member and the second lens group.

In an embodiment, the optical imaging system may satisfy 1<G1_MED/PED<1.3 (Conditional Expression 11). In this case, G1_MED is the maximum effective diameter of one or two lenses included in the first lens group. For example, G1_MED may be the effective diameter of the object-side surface of the first lens. PED is the minor axis length of the incident surface of the reflective member. For example, the incident surface of the reflective member may be a rectangle. In this case, PED is a length of a short side of the rectangle. Therefore, an image brightness may be improved by adjusting the effective diameter of the first lens.

In an embodiment, the optical imaging system may satisfy 0.6<RG1_S1/RG1_S2<0.8 (Conditional Expression 12). Therefore, a sufficient space in which the reflective member may rotate when compensating for shake may be secured.

In an embodiment, the optical imaging system may satisfy 0.18<D2/L<0.45 (Conditional Expression 13). In this case, D2 is the distance on the optical axis from the object-side surface of a first lens (for example, the second lens) of the second lens group to the image-side surface of the last lens (for example, the fifth lens, the sixth lens, or the seventh lens) of the second lens group. Therefore, aberrations may be significantly reduced and the optical imaging system may be miniaturized.

In an embodiment, the optical imaging system may satisfy 0.35<f/fG1≤0.5 (Conditional Expression 14). In this case, f is the total focal length of the optical imaging system. Therefore, the angle of light incident on the reflective member may be reduced by adjusting the focal length of the first lens group disposed in front of the reflective member, and thus a resolution deterioration due to a rotation of the reflective member may be significantly reduced.

In an embodiment, the optical imaging system may satisfy 0.6<f/fG2≤1.1 (Conditional Expression 15). Therefore, by appropriately distributing the refractive power of each lens group, the optical imaging system may be miniaturized and a resolution may be improved.

In an embodiment, the optical imaging system may satisfy 1.3<fG1/fG2<3 (Conditional Expression 16). Therefore, by appropriately distributing the refractive power of each lens group, the optical imaging system may be miniaturized and a resolution may be improved.

In an embodiment, the optical imaging system may satisfy 0.3<D12P/DP21<0.6 (Conditional Expression 17). Therefore, the optical imaging system may be miniaturized, and a sufficient space for rotating the reflective member during shake correction may be secured.

In an embodiment, the optical imaging system may satisfy 0.7<G2_MED/Lf<1.4 (Conditional Expression 18). In this case, G2_MED is the effective diameter of the lens with the largest effective diameter among the lenses included in the second lens group. Therefore, the optical imaging system may be miniaturized while securing the brightness of the optical imaging system.

In an embodiment, the optical imaging system may satisfy 0.25<G1_MED/Lr<0.42 (Conditional Expression 19). Therefore, the optical imaging system may be miniaturized while securing the brightness of the optical imaging system.

In an embodiment, the optical imaging system may satisfy 5.3<Fno×(fG1/f)<7.7 (Conditional Expression 20). In this case, Fno is the F-number of the optical imaging system. Therefore, an image brightness and a resolution may be improved.

In an embodiment, the optical imaging system may satisfy 0.35 (°/mm)<FOV/Lr<0.7 (°/mm) (Conditional Expression 21). In this case, FOV is the half angle of view of the optical imaging system. Therefore, a telephoto performance may be improved while miniaturizing the optical imaging system.

FIG. 1A is a configuration diagram of an optical imaging system according to a first embodiment when shooting an object at an infinite distance, and FIG. 1B is a configuration diagram of the optical imaging system according to the first embodiment when shooting an object at a near-focus position, i.e., a nearest position of an object at which the optical imaging system can focus an image of the object.

The optical imaging system according to the first embodiment will be described with reference to FIGS. 1A and 1B.

The optical imaging system according to the first embodiment includes a first lens group G1 and a second lens group G2. Moreover, the optical imaging system includes a reflective member P disposed in front of the second lens group G2.

In order from the object side, the first lens group G1 includes a first lens 110, and the second lens group G2 includes a second lens 120, a third lens 130, a fourth lens 140, a fifth lens 150, and a sixth lens 160.

The first lens group G1 may further include a reflective member P disposed between the first lens 110 and the second lens 120. An aperture may be disposed between the third lens 130 and the fourth lens 140.

The first lens 110 to the sixth lens 160 are made of a plastic material.

Additionally, the optical imaging system may further include a filter 180 and an image sensor.

The optical imaging system according to the first embodiment may form a focus on an imaging plane 190. The imaging plane 190 may refer to a surface on which a focus is formed by an optical imaging system. As an example, the imaging plane 190 may refer to one surface of the image sensor receiving light.

In the first embodiment, the reflective member P may be a prism, but alternatively may be a mirror.

The first lens group G1 is fixedly disposed, and the second lens group G2 may be moved along the optical axis for focus adjustment.

The characteristics of each lens (a radius of curvature, a thickness of the lens or a distance between lenses, a refractive index, an Abbe number, a focal length, and an effective radius) are illustrated in Table 1 below.

TABLE 1

| Surface | | Radius of | Thickness/ | Refractive | Abbe | Focal | Effective | Lens |
|---|---|---|---|---|---|---|---|---|
| No. | Element | Curvature | Distance | Index | Number | Length | Radius | Group |
| Object | | | D0 | | | | | |
| S1 | First | 8.092 | 1.300 | 1.5349 | 55.74 | 38.0026 | 3.480 | First |
| S2 | Lens | 12.654 | 2.046 | | | | 3.221 | Lens |
| | | | | | | | | Group |
| S3 | Prism | Infinity | 2.250 | 1.7847 | 25.72 | | 2.960 | |
| S4 | | Infinity | 2.250 | 1.7847 | 25.72 | | 2.784 | |
| S5 | | Infinity | D1 | | | | 2.620 | |
| S6 | Second | 3.393 | 1.253 | 1.5349 | 55.74 | 5.7744 | 2.060 | Second |
| S7 | Lens | −31.504 | 0.165 | | | | 1.920 | Lens |
| S8 | Third | −40.723 | 0.786 | 1.6144 | 25.94 | −4.3276 | 1.834 | Group |
| S9 | Lens | 2.894 | 0.583 | | | | 1.494 | |
| S10 | Fourth | −35.858 | 0.619 | 1.5440 | 55.99 | −42.0562 | 1.495 | |
| S11 | Lens | 64.351 | 0.367 | | | | 1.527 | |
| S12 | Fifth | −8.018 | 0.831 | 1.6608 | 20.38 | 24.4816 | 1.543 | |
| S13 | Lens | −5.605 | 0.100 | | | | 1.698 | |
| S14 | Sixth | 52.801 | 0.480 | 1.6392 | 23.49 | 32.3864 | 1.746 | |
| S15 | Lens | −34.489 | D2 | | | | 1.800 | |
| S16 | Filter | Infinity | 0.210 | 1.5168 | 64.20 | | 2.896 | |
| S17 | | Infinity | D3 | | | | 2.919 | |
| S18 | Imaging | Infinity | 0.006 | | | | | |
| | Plane | | | | | | | |

TABLE 2

| | Object at Near |
|---|---|
| Object at Infinity | Focus Position |

| | | | |
|---|---|---|---|
| D0 | Infinity | D0 | 300 |
| D1 | 3.560 | D1 | 2.040 |
| D2 | 4.838 | D2 | 6.358 |
| D3 | 3.900 | D3 | 3.900 |
| f | 18.610 | MAG | 0.063 |
| FOV | 10.751 | FOV | 10.013 |
| Fno | 3.225 | Fno | 3.606 |
| L | 25.544 | L | 25.544 |

In Table 2 above, D0 is the object distance, i.e., the distance on the optical axis from the object to the object-side surface of the first lens 110, D1 is the distance on the optical axis between the reflective member P and the second lens 120, D2 is the distance on the optical axis between the sixth lens 160 and the filter 180, and D3 is the distance on the optical axis between the filter 180 and the imaging plane 190.

Moreover, f is the total focal length of the optical imaging system, MAG is the magnification of the optical imaging system, FOV is the half angle of view of the optical imaging system, Fno is the f-number of the optical imaging system, and L is the distance on the optical axis from the object-side surface of the first lens 110 to the imaging plane 190. Magnification may refer to the ratio of the size of the image to the size of the object.

For reference, in Table 1, the effective radius of the prism may refer to the length of the surface (for example, an incident surface, a reflection surface, and an exit surface) of the prism in the minor axis direction.

In the first embodiment, the first lens group G1 has a positive refractive power overall, and the second lens group G2 has a positive refractive power overall.

The focal length fG1 of the first lens group G1 is 38.0026 mm, and the focal length fG2 of the second lens group G2 is 27.169 mm.

The effective radius of the object-side surface of the first lens 110 of the first lens group G1 is larger than the effective radius of the image-side surface thereof. The effective radius of the object-side surface of the first lens 110 is 3.480 mm.

In the second lens group G2, the effective radius of the object-side surface of the second lens 120 is the largest. The effective radius of the object-side surface of the second lens 120 is 2.060 mm.

The first lens 110 has a positive refractive power, the object-side surface of the first lens 110 is convex in a paraxial region thereof, and the image-side surface of the first lens 110 is concave in a paraxial region thereof.

The second lens 120 has a positive refractive power, and the object-side surface and the image-side surface of the second lens 120 are convex in paraxial regions thereof.

The third lens 130 has a negative refractive power, and the object-side surface and the image-side surface of the third lens 130 are concave in paraxial regions thereof.

The fourth lens 140 has a negative refractive power, and the object-side surface and the image-side surface of the fourth lens 140 are concave in paraxial regions thereof.

The fifth lens 150 has a positive refractive power, the object-side surface of the fifth lens 150 is concave in a paraxial region thereof, and the image-side surface of the fifth lens 150 is convex in a paraxial region thereof.

The sixth lens 160 has a positive refractive power, and the object-side surface and the image-side surface of the sixth lens 160 are convex in paraxial regions thereof.

Each surface of the first to sixth lenses 110 to 160 has aspherical coefficients as illustrated in Table 3 below. For example, the object-side surface and the image-side surface of each of the first to sixth lenses 110 to 160 are aspherical.

TABLE 3

| | S1 | S2 | S6 | S7 | S8 | S9 |
|---|---|---|---|---|---|---|
| Conic | −3.67624 | 6.7425 | 0.04666 | 0 | 0 | −0.21689 |
| Constant (K) | | | | | | |
| 4th | 1.78995E−03 | 9.32314E−04 | 9.61136E−04 | −3.11576E−04 | −7.11960E−03 | −6.52086E−03 |
| Coefficient (A) | | | | | | |
| 6th | −2.76147E−04 | −4.64310E−04 | 2.26543E−04 | 9.81894E−03 | 1.01349E−02 | −1.16661E−02 |
| Coefficient (B) | | | | | | |
| 8th | 1.28341E−04 | 2.42666E−04 | −1.15303E−03 | −1.94959E−02 | −1.54754E−02 | 5.96379E−02 |
| Coefficient (C) | | | | | | |
| 10th | −3.48103E−05 | −7.44749E−05 | 1.35315E−03 | 2.18543E−02 | 1.94518E−02 | −1.11329E−01 |
| Coefficient (D) | | | | | | |
| 12th | 5.97943E−06 | 1.44101E−05 | −8.47234E−04 | −1.44322E−02 | −1.48226E−02 | 1.22131E−01 |
| Coefficient (E) | | | | | | |

| | S10 | S11 | S12 | S13 | S14 | S15 |
|---|---|---|---|---|---|---|
| Conic | 0 | 0 | 0 | 0 | −99 | 99 |
| Constant (K) | | | | | | |
| 4th | 7.47375E−03 | 1.39752E−02 | 2.99031E−03 | 3.43949E−03 | −6.23216E−03 | −8.96325E−03 |
| Coefficient (A) | | | | | | |
| 6th | −2.43642E−02 | −3.17552E−02 | −2.44840E−02 | −1.04761E−02 | −3.33782E−04 | −4.39623E−04 |
| Coefficient (B) | | | | | | |
| 8th | 7.51370E−02 | 7.71784E−02 | 6.17747E−02 | 1.93086E−02 | −1.03250E−04 | −4.24815E−05 |
| Coefficient (C) | | | | | | |
| 10th | −1.32811E−01 | −1.14418E−01 | −9.21027E−02 | −2.05465E−02 | 6.94273E−06 | −1.76947E−06 |
| Coefficient (D) | | | | | | |
| 12th | 1.43123E−01 | 1.08381E−01 | 8.77413E−02 | 1.39287E−02 | −8.32988E−06 | −1.59623E−06 |
| Coefficient (E) | | | | | | |

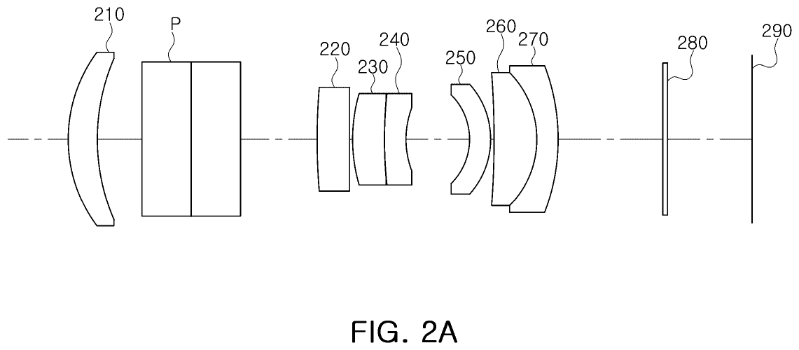

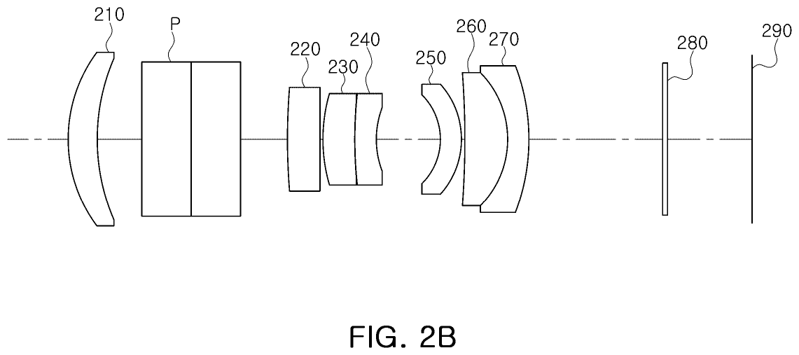

FIG. 2A is a configuration diagram of an optical imaging system according to a second embodiment when shooting an object at an infinite distance, and FIG. 2B is a configuration diagram of the optical imaging system according to the second embodiment when shooting an object at a near-focus position, i.e., a nearest position of an object at which the optical imaging system can focus an image of the object.

The optical imaging system according to the second embodiment will be described with reference to FIGS. 2A and 2B.

The optical imaging system according to the second embodiment includes a first lens group G1 and a second lens group G2. Moreover, the optical imaging system includes a reflective member P disposed in front of the second lens group G2.

In order from the object side, the first lens group G1 includes a first lens 210, and the second lens group G2 includes a second lens 220, a third lens 230, a fourth lens 240, a fifth lens 250, a sixth lens 260, and a seventh lens 270.

The first lens group G1 may further include a reflective member P disposed between the first lens 210 and the second lens 220. An aperture may be disposed between the fourth lens 240 and the fifth lens 250.

The first lens 210 is made of a plastic material, and the second to seventh lenses 220 to 270 are made of glass.

Additionally, the optical imaging system may further include a filter 280 and an image sensor.

The optical imaging system according to the second embodiment may form a focus on an imaging plane 290. The imaging plane 290 may refer to a surface on which a focus is formed by the optical imaging system. As an example, the imaging plane 290 may refer to one surface of the image sensor receiving light.

In the second embodiment, the reflective member P may be a prism, but alternatively may be a mirror.

The first lens group G1 is fixedly disposed, and the second lens group G2 may be moved along the optical axis for focus adjustment.

The characteristics of each lens (a radius of curvature, a thickness of the lens or a distance between lenses, a refractive index, an Abbe number, a focal length, and an effective radius) are illustrated in Table 4 below.

TABLE 4

| Surface | | Radius of | Thickness/ | Refractive | Abbe | Focal | Effective | Lens |
|---|---|---|---|---|---|---|---|---|
| No. | Element | Curvature | Distance | Index | Number | Length | Radius | Group |
| Object | | | D0 | | | | | |
| S1 | First | 8.092 | 1.300 | 1.5349 | 55.74 | 38.0026 | 4.000 | First |
| S2 | Lens | 12.654 | 2.046 | | | | 3.731 | Lens |
| | | | | | | | | Group |
| S3 | Prism | Infinity | 2.250 | 1.7847 | 25.72 | | 3.486 | |
| S4 | | Infinity | 2.250 | 1.7847 | 25.72 | | 3.249 | |
| S5 | | Infinity | D1 | | | | 3.013 | |
| S6 | Second | 34.792 | 1.500 | 1.8340 | 37.34 | 39.6483 | 2.396 | Second |
| S7 | Lens | −749.011 | 0.100 | | | | 2.220 | Lens |
| S8 | Third | 7.243 | 1.500 | 1.7995 | 42.34 | 12.3669 | 2.121 | Group |
| | Lens | | | | | | | |
| S9 | Fourth | 24.212 | 1.000 | 1.8467 | 23.78 | −7.1254 | 1.788 | |
| S10 | Lens | 4.775 | 0.246 | | | | 1.482 | |
| S11 | Aperture | Infinity | 2.635 | | | | 1.480 | |
| S12 | Fifth | −2.949 | 1.000 | 1.8052 | 25.46 | −35.8453 | 2.054 | |
| S13 | Lens | −3.780 | 0.100 | | | | 2.543 | |
| S14 | Sixth | −53.424 | 2.000 | 1.8061 | 40.73 | 5.8206 | 2.897 | |
| | Lens | | | | | | | |
| S15 | Seventh | −4.409 | 1.000 | 1.7282 | 28.32 | −13.3079 | 3.074 | |
| S16 | Lens | −8.805 | D2 | | | | 3.365 | |
| S17 | Filter | Infinity | 0.210 | 1.51680 | 64.20 | | 3.488 | |
| S18 | | Infinity | D3 | | | | 3.491 | |
| S19 | Imaging | Infinity | 0.000 | | | | | |
| | Plane | | | | | | | |

TABLE 5

| | Object at Near |
|---|---|
| Object at Infinity | Focus Position |

| | | | |
|---|---|---|---|
| D0 | Infinity | D0 | 300 |
| D1 | 3.560 | D1 | 2.173 |
| D2 | 4.799 | D2 | 6.186 |
| D3 | 3.9 | D3 | 3.9 |
| f | 18.606 | MAG | 0.060 |
| FOV | 10.907 | FOV | 10.772 |
| Fno | 3.224 | Fno | 3.445 |
| L | 31.396 | L | 31.396 |

In Table 5 above, D0 is the object distance, i.e., the distance on the optical axis from the object to the object-side surface of the first lens 210, D1 is the distance on the optical axis between the reflective member P and the second lens 220, D2 is the distance on the optical axis between the seventh lens 270 and the filter 280, and D3 is the distance on the optical axis between the filter 280 and the imaging plane 290.

Moreover, f is the total focal length of the optical imaging system, MAG is the magnification of the optical imaging system, FOV is the half angle of view of the optical imaging system, Fno is the f-number of the optical imaging system, and L is the distance on the optical axis from the object-side surface of the first lens 210 to the imaging plane 290. Magnification may refer to the ratio of the size of the image to the size of the object.

In the second embodiment, the first lens group G1 has a positive refractive power overall, and the second lens group G2 has a positive refractive power overall.

The focal length fG1 of the first lens group G1 is 38.0026 mm, and the focal length fG2 of the second lens group G2 is 17.181 mm.

The effective radius of the object-side surface of the first lens 210 of the first lens group G1 is larger than the effective radius of the image-side surface thereof. The effective radius of the object-side surface of the first lens 210 is 4.000 mm.

In the second lens group G2, the effective radius of the image-side surface of the seventh lens 270 is the largest. The effective radius of the image-side surface of the seventh lens 270 is 3.365 mm.

The first lens 210 has a positive refractive power, the object-side surface of the first lens 210 is convex in a paraxial region thereof, and the image-side surface of the first lens 210 is concave in a paraxial region thereof.

The second lens 220 has a positive refractive power, and the object-side surface and the image-side surface of the second lens 220 convex in paraxial regions thereof.

The third lens 230 has a positive refractive power, the object-side surface of the third lens 230 is convex in a paraxial region thereof, and the image-side surface of the third lens 230 is concave in a paraxial region thereof.

The fourth lens 240 has a negative refractive power, the object-side surface of the fourth lens 240 is convex in a paraxial region thereof, and the image-side surface of the fourth lens 240 is concave in a paraxial region thereof.

The fifth lens 250 has a negative refractive power, the object-side surface of the fifth lens 250 is concave in a paraxial region thereof, and the image-side surface of the fifth lens 250 is convex in a paraxial region thereof.

The sixth lens 260 has a positive refractive power, the object-side surface of the sixth lens 260 is concave in a paraxial region thereof, and the image-side surface of the sixth lens 260 is convex in a paraxial region thereof.

The seventh lens 270 has a negative refractive power, the object-side surface of the seventh lens 270 is concave in a paraxial region thereof, and the image-side surface of the seventh lens 270 is convex in a paraxial region thereof.

Also, the third lens 230 and the fourth lens 240 may be bonded to each other to form a cemented lens. The sixth lens 260 and the seventh lens 270 may be bonded to each other to form a cemented lens.

Each surface of the first lens 210 has aspherical coefficients as illustrated in Table 6. For example, the object-side surface and the image-side surface of the first lens 210 are aspherical.

TABLE 6

| | S1 | S2 |
|---|---|---|
| Conic Constant (K) | 1.221522 | 3.160944 |
| 4th Coefficient (A) | 2.61543E−05 | 3.21779E−04 |
| 6th Coefficient (B) | 1.46259E−05 | 2.25792E−05 |
| 8th Coefficient (C) | −5.06176E−07 | −4.51403E−07 |
| 10th Coefficient (D) | 1.03401E−08 | 3.31379E−08 |
| 12th Coefficient (E) | 2.07931E−09 | 3.78068E−09 |

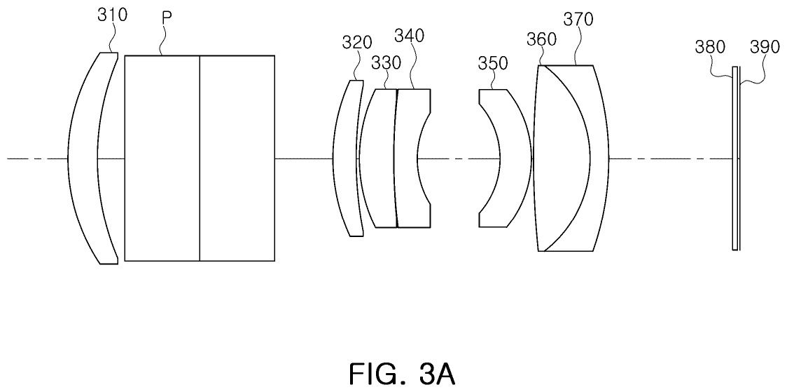

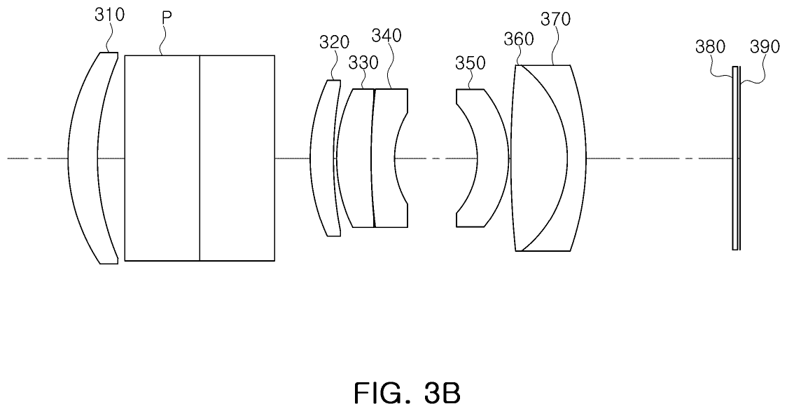

FIG. 3A is a configuration diagram of an optical imaging system according to a third embodiment when shooting an object at an infinite distance, and FIG. 3B is a configuration diagram of the optical imaging system according to the third embodiment when shooting an object at a near-focus position, i.e., a nearest position of an object at which the optical imaging system can focus an image of the object.

The optical imaging system according to the third embodiment will be described with reference to FIGS. 3A and 3B.

The optical imaging system according to the third embodiment includes a first lens group G1 and a second lens group G2. Moreover, the optical imaging system includes a reflective member P disposed in front of the second lens group G2.

In order from the object side, the first lens group G1 includes a first lens 310, and the second lens group G2 includes a second lens 320, a third lens 330, a fourth lens 340, a fifth lens 350, a sixth lens 360, and a seventh lens 370.

The first lens group G1 may further include a reflective member P disposed between the first lens 310 and the second lens 320. An aperture may be disposed between the fourth lens 340 and the fifth lens 350.

The first lens 310 is made of a plastic material, and the second to seventh lenses 320 to 370 are made of glass.

Additionally, the optical imaging system may further include a filter 380 and an image sensor.

The optical imaging system according to the third embodiment may form a focus on an imaging plane 390. The imaging plane 390 may refer to a surface on which a focus is formed by the optical imaging system. As an example, the imaging plane 390 may refer to one surface of the image sensor receiving light.

In the third embodiment, the reflective member P may be a prism, but alternatively may be a mirror.

The first lens group G1 is fixedly disposed, and the second lens group G2 may be moved along the optical axis for focus adjustment.

The characteristics of each lens (a radius of curvature, a thickness of the lens or a distance between lenses, a refractive index, an Abbe number, a focal length, and an effective radius) are illustrated in Table 7 below.

TABLE 7

| Surface | | Radius of | Thickness/ | Refractive | Abbe | Focal | Effective | Lens |
|---|---|---|---|---|---|---|---|---|
| No. | Element | Curvature | Distance | Index | Number | Length | Radius | Group |
| Object | | | D0 | | | | | |
| S1 | First | 9.041 | 1.300 | 1.5349 | 55.74 | 44.8451 | 4.500 | First |
| S2 | Lens | 13.746 | 1.150 | | | | 4.270 | Lens |
| | | | | | | | | Group |
| S3 | Prism | Infinity | 3.200 | 1.9229 | 20.88 | | 4.225 | |
| S4 | | Infinity | 3.200 | 1.9229 | 20.88 | | 3.975 | |
| S5 | | Infinity | D1 | | | | 3.725 | |
| S6 | Second | 8.103 | 1.000 | 1.8340 | 37.34 | 16.5199 | 3.300 | Second |
| S7 | Lens | 18.400 | 0.100 | | | | 3.138 | Lens |
| S8 | Third | 6.737 | 1.500 | 1.7995 | 42.34 | 10.6103 | 2.942 | Group |
| | Lens | | | | | | | |
| S9 | Fourth | 28.863 | 1.000 | 1.8467 | 23.78 | −5.1144 | 2.539 | |
| S10 | Lens | 3.737 | 0.757 | | | | 1.939 | |
| S11 | Aperture | Infinity | 2.724 | | | | 1.880 | |
| S12 | Fifth | −3.538 | 1.350 | 1.8052 | 25.46 | −39.3956 | 2.317 | |
| S13 | Lens | −4.658 | 0.100 | | | | 2.927 | |
| S14 | Sixth | 42.683 | 2.400 | 1.8061 | 40.73 | 5.6080 | 3.325 | |
| | Lens | | | | | | | |
| S15 | Seventh | −4.961 | 0.800 | 1.7282 | 28.32 | −12.1172 | 3.441 | |
| S16 | Lens | −11.978 | D2 | | | | 3.600 | |
| S17 | Filter | Infinity | 0.210 | 1.51680 | 64.20 | | 3.901 | |
| S18 | | Infinity | D3 | | | | 3.908 | |
| S19 | Imaging | Infinity | 0.000 | | | | | |
| | Plane | | | | | | | |

TABLE 8

| | Object at Near |
|---|---|
| Object at Infinity | Focus Position |

| | | | |
|---|---|---|---|
| D0 | Infinity | D0 | 300 |
| D1 | 2.5013233 | D1 | 1.5002783 |
| D2 | 5.2766767 | D2 | 6.2777217 |
| D3 | 0.1 | D3 | 0.1 |
| f | 16.568867 | MAG | 0.0536437 |
| FOV | 13.317728 | FOV | 13.071731 |
| Fno | 2.1232124 | Fno | 2.2332814 |
| L | 28.669 | L | 28.669 |

In Table 8 above, D0 is the object distance, i.e., the distance on the optical axis from the object to the object-side surface of the first lens 310, D1 is the distance on the optical axis between the reflective member P and the second lens 320, D2 is the distance on the optical axis between the seventh lens 370 and the filter 380, and D3 is the distance on the optical axis between the filter 380 and the imaging plane 390.

Moreover, f is the total focal length of the optical imaging system, MAG is the magnification of the optical imaging system, FOV is the half angle of view of the optical imaging system, Fno is the f-number of the optical imaging system, and L is the distance on the optical axis from the object-side surface of the first lens 310 to the imaging plane 390. Magnification may refer to the ratio of the size of the image to the size of the object.

In the third embodiment, the first lens group G1 has a positive refractive power overall, and the second lens group G2 has a positive refractive power overall.

The focal length fG1 of the first lens group G1 is 44.8451 mm, and the focal length fG2 of the second lens group G2 is 15.162 mm.

The effective radius of the object-side surface of the first lens 310 of the first lens group G1 is larger than the effective radius of the image-side surface thereof. The effective radius of the object-side surface of the first lens 310 is 4.500 mm.

In the second lens group G2, the effective radius of the image-side surface of the seventh lens 370 is the largest. The effective radius of the image-side surface of the seventh lens 370 is 3.600 mm.

The first lens 310 has a positive refractive power, the object-side surface of the first lens 310 is convex in a paraxial region thereof, and the image-side surface of the first lens 310 is concave in a paraxial region thereof.

The second lens 320 has a positive refractive power, the object-side surface of the second lens 320 is convex in a paraxial region thereof, and the image-side surface of the second lens 320 is concave in a paraxial region thereof.

The third lens 330 has a positive refractive power, the object-side surface of the third lens 330 is convex in a paraxial region thereof, and the image-side surface of the third lens 330 is concave in a paraxial region thereof.

The fourth lens 340 has a negative refractive power, the object-side surface of the fourth lens 340 is convex in a paraxial region thereof, and the image-side surface of the fourth lens 340 is concave in a paraxial region thereof.

The fifth lens 350 has a negative refractive power, the object-side surface of the fifth lens 350 is concave in a paraxial region thereof, and the image-side surface of the fifth lens 350 is convex in a paraxial region thereof.

The sixth lens 360 has a positive refractive power, and the object-side surface and the image-side surface of the sixth lens 360 are convex in paraxial regions thereof.

The seventh lens 370 has a negative refractive power, the object-side surface of the seventh lens 370 is concave in a paraxial region thereof, and the image-side surface of the seventh lens 370 is convex in a paraxial region thereof.

Also, the third lens 330 and the fourth lens 340 may be bonded to each other to form a cemented lens. The sixth lens 360 and the seventh lens 370 may be bonded to each other to form a cemented lens.

Each surface of the first lens 310 has aspheric coefficients as illustrated in Table 9 below. For example, the object-side surface and the image-side surface of the first lens 310 are aspherical.

TABLE 9

| | S1 | S2 |
|---|---|---|
| Conic Constant (K) | 1.289207 | 1.162132 |
| 4th Coefficient (A) | −9.92787E−05 | 1.50572E−04 |
| 6th Coefficient (B) | 1.00942E−05 | 2.09452E−05 |
| 8th Coefficient (C) | −3.42253E−07 | −7.42242E−07 |
| 10th Coefficient (D) | −2.73513E−09 | 1.57232E−08 |
| 12th Coefficient (E) | 5.53729E−10 | 7.59993E−10 |

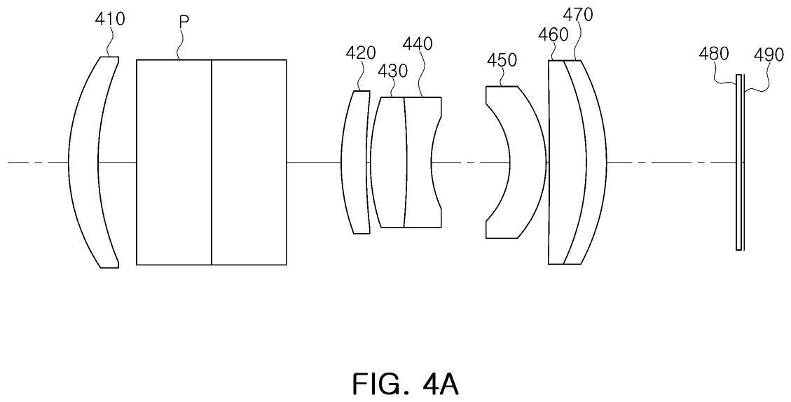

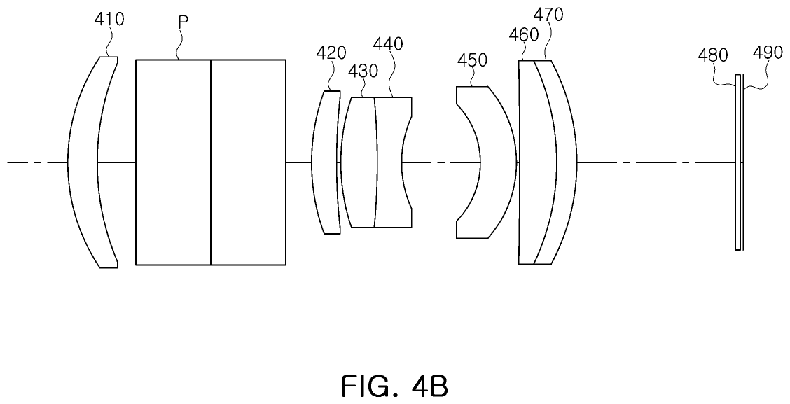

FIG. 4A is a configuration diagram of an optical imaging system according to a fourth embodiment when shooting an object at an infinite distance, and FIG. 4B is a configuration diagram of the optical imaging system according to the fourth embodiment when shooting an object at a near-focus position, i.e., a nearest position of an object at which the optical imaging system can focus an image of the object.

The optical imaging system according to the fourth embodiment will be described with reference to FIGS. 4A and 4B.

The optical imaging system according to the fourth embodiment includes a first lens group G1 and a second lens group G2. Moreover, the optical imaging system includes a reflective member P disposed in front of the second lens group G2.

In order from the object side, the first lens group G1 includes a first lens 410, and the second lens group G2 includes a second lens 420, a third lens 430, a fourth lens 440, a fifth lens 450, a sixth lens 460, and a seventh lens 470.

The first lens group G1 may further include a reflective member P disposed between the first lens 410 and the second lens 420. An aperture may be disposed between the fourth lens 440 and the fifth lens 450.

The first lens 410 is made of a plastic material, and the second to seventh lenses 420 to 470 are made of glass.

Additionally, the optical imaging system may further include a filter 480 and an image sensor.

The optical imaging system according to the fourth embodiment may form a focus on an imaging plane 490. The imaging plane 490 may refer to a surface on which a focus is formed by the optical imaging system. As an example, the imaging plane 490 may refer to one surface of the image sensor receiving light.

In the fourth embodiment, the reflective member P may be a prism, but alternatively may be a mirror.

The first lens group G1 is fixedly disposed, and the second lens group G2 may be moved along the optical axis for focus adjustment.

The characteristics of each lens (a radius of curvature, a thickness of the lens or a distance between lenses, a refractive index, an Abbe number, a focal length, and an effective radius) are as illustrated in Table 10 below.

TABLE 10

| Surface | | Radius of | Thickness/ | Refractive | Abbe | Focal | Effective | Lens |
|---|---|---|---|---|---|---|---|---|
| No. | Element | Curvature | Distance | Index | Number | Length | Radius | Group |
| Object | | | D0 | | | | | |
| S1 | First | 7.987 | 1.300 | 1.5349 | 55.74 | 44.2579 | 4.519 | First |
| S2 | Lens | 11.344 | 1.020 | | | | 4.215 | Lens |
| | | | | | | | | Group |
| S3 | Prism | Infinity | 3.100 | | | | 4.201 | |
| S4 | | Infinity | 3.100 | | | | 3.463 | |
| S5 | | Infinity | D1 | | | | 3.160 | |
| S6 | Second | 9.010 | 1.000 | 1.8340 | 37.34 | 15.2952 | 2.872 | Second |
| S7 | Lens | 28.691 | 0.100 | | | | 2.735 | Lens |
| S8 | Third | 7.411 | 1.500 | 1.7995 | 42.34 | 7.7143 | 2.601 | Group |
| | Lens | | | | | | | |
| S9 | Fourth | −34.597 | 1.000 | 1.8467 | 23.78 | −4.3720 | 2.280 | |
| S10 | Lens | 4.247 | 0.415 | | | | 1.839 | |
| S11 | Aperture | Infinity | 2.759 | | | | 1.800 | |
| S12 | Fifth | −3.326 | 1.500 | 1.8052 | 25.46 | −30.5942 | 2.328 | |
| S13 | Lens | −4.616 | 0.100 | | | | 3.044 | |
| S14 | Sixth | −189.901 | 1.500 | 1.8061 | 40.73 | 12.4037 | 3.444 | |
| | Lens | | | | | | | |
| S15 | Seventh | −9.585 | 0.800 | 1.7282 | 28.32 | 111.7716 | 3.596 | |
| S16 | Lens | −8.886 | D2 | | | | 3.716 | |
| S17 | Filter | Infinity | 0.210 | 1.51680 | 64.20 | | 3.544 | |
| S18 | | Infinity | D3 | | | | 3.540 | |
| S19 | Imaging | Infinity | 0.000 | | | | | |
| | Plane | | | | | | | |

TABLE 11

| | Object at Near |
|---|---|
| Object at Infinity | Focus Position |

| | | | |
|---|---|---|---|
| D0 | Infinity | D0 | 300 |
| D1 | 2.68363739 | D1 | 1.50042214 |
| D2 | 5.26836261 | D2 | 6.45157786 |
| D3 | 0.1 | D3 | 0.1 |
| f | 17.89686203 | MAG | 0.05731942 |
| FOV | 11.17236026 | FOV | 10.89345097 |
| Fno | 2.24842307 | Fno | 2.39539911 |
| L | 27.456 | L | 27.456 |

In Table 11 above, D0 is the object distance, i.e., the distance on the optical axis from the object to the object-side surface of the first lens 410, D1 is the distance on the optical axis between the reflective member P and the second lens 420, D2 is the distance on the optical axis between the seventh lens 470 and the filter 480, and D3 is the distance on the optical axis between the filter 480 and the imaging plane 490.

Moreover, f is the total focal length of the optical imaging system, MAG is the magnification of the optical imaging system, FOV is the half angle of view of the optical imaging system, Fno is the f-number of the optical imaging system, and L is the distance on the optical axis from the object-side surface of the first lens 410 to the imaging plane 490. Magnification may refer to the ratio of the size of the image to the size of the object.

In the fourth embodiment, the first lens group G1 has a positive refractive power overall, and the second lens group G2 has a positive refractive power overall.

The focal length fG1 of the first lens group G1 is 44.2579 mm, and the focal length fG2 of the second lens group G2 is 18.335 mm.

The effective radius of the object-side surface of the first lens 410 of the first lens group G1 is larger than the effective radius of the image-side surface. The effective radius of the object-side surface of the first lens 410 is 4.519 mm.

In the second lens group G2, the effective radius of the image-side surface the seventh lens 470 is the largest. The effective radius of the image-side surface of the seventh lens 470 is 3.716 mm.

The first lens 410 has a positive refractive power, the object-side surface of the first lens 410 is convex in a paraxial region thereof, and the image-side surface of the first lens 410 is concave in a paraxial region thereof.

The second lens 420 has a positive refractive power, the object-side surface of the second lens 420 is convex in a paraxial region thereof, and the image-side surface of the second lens 420 is concave in a paraxial region thereof.

The third lens 430 has a positive refractive power, and the object-side surface and the image-side surface of the third lens 430 are convex in paraxial regions thereof.

The fourth lens 440 has a negative refractive power, and the object-side surface and the image-side surface of the fourth lens 440 are concave in paraxial regions thereof.

The fifth lens 450 has a negative refractive power, the object-side surface of the fifth lens 450 is concave in a paraxial region thereof, and the image-side surface of the fifth lens 450 is convex in a paraxial region thereof.

The sixth lens 460 has a positive refractive power, the object-side surface of the sixth lens 460 is concave in a paraxial region thereof, and the image-side surface of the sixth lens 460 is convex in a paraxial region thereof.

The seventh lens 470 has a positive refractive power, the object-side surface of the seventh lens 470 is concave in a paraxial region thereof, and the image-side surface of the seventh lens 470 is convex in a paraxial region thereof.

Also, the third lens 430 and the fourth lens 440 may be bonded to each other to form a cemented lens. The sixth lens 460 and the seventh lens 470 may be bonded to each other to form a cemented lens.

Each surface of the first lens 410 has aspheric coefficients as illustrated in Table 12 below. For example, the object-side surface and the image-side surface of the first lens 410 are aspherical.

TABLE 12

| | S1 | S2 |
|---|---|---|
| Conic Constant (K) | 0.9770469 | 0.9585413 |
| 4th Coefficient (A) | −1.64295E−04 | 1.24680E−04 |
| 6th Coefficient (B) | 7.29153E−06 | 1.53377E−05 |
| 8th Coefficient (C) | −4.45966E−07 | −3.29263E−07 |
| 10th Coefficient (D) | 6.56542E−09 | 3.90790E−09 |
| 12th Coefficient (E) | 2.70274E−10 | 1.01983E−09 |

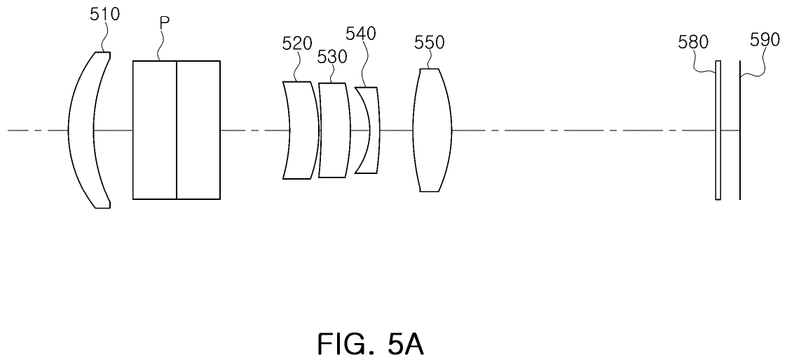

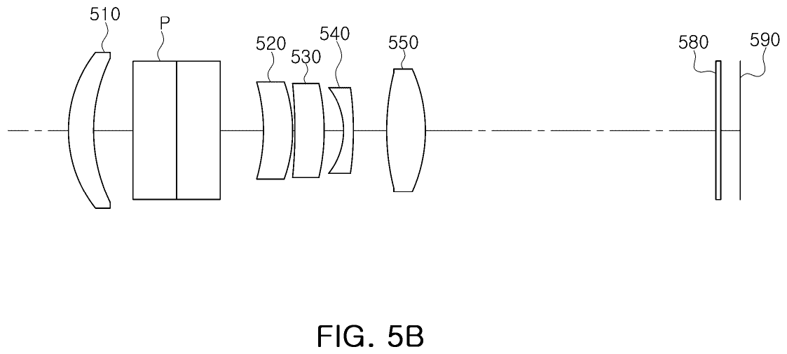

FIG. 5A is a configuration diagram of an optical imaging system according to a fifth embodiment when shooting an object at an infinite distance, and FIG. 5B is a configuration diagram of the optical imaging system according to the fifth embodiment when shooting an object at a near-focus position, i.e., a nearest position of an object at which the optical imaging system can focus an image of the object.

The optical imaging system according to the fifth embodiment will be described with reference to FIGS. 5A and 5B.

The optical imaging system according to the fifth embodiment includes a first lens group G1 and a second lens group G2. Moreover, the optical imaging system includes a reflective member P disposed in front of the second lens group G2.

In order from the object side, the first lens group G1 includes a first lens 510, and the second lens group G2 includes a second lens 520, a third lens 530, a fourth lens 540, and a fifth lens 550.

The first lens group G1 may further include a reflective member P disposed between the first lens 510 and the second lens 520. An aperture may be disposed between the fourth lens 540 and the fifth lens 550.

The first lens 510, the fourth lens 540, and the fifth lens 550 are made of a plastic material, and the second lens 520 and the third lens 530 are made of glass.

Additionally, the optical imaging system may further include a filter 580 and an image sensor.

The optical imaging system according to the fifth embodiment may form a focus on an imaging plane 590. The imaging plane 590 may refer to a surface on which a focus is formed by the optical imaging system. As an example, the imaging plane 590 may refer to one surface of the image sensor receiving light.

In the fifth embodiment, the reflective member P may be a prism, but alternatively may be a mirror.

The first lens group G1 is fixedly disposed, and the second lens group G2 may be moved along the optical axis for focus adjustment.

The characteristics of each lens (a radius of curvature, a thickness of the lens or a distance between lenses, a refractive index, an Abbe number, a focal length, and an effective radius) are illustrated in Table 13 below.

TABLE 13

| Surface | | Radius of | Thickness/ | Refractive | Abbe | Focal | Effective | Lens |
|---|---|---|---|---|---|---|---|---|
| No. | Element | Curvature | Distance | Index | Number | Length | Radius | Group |
| Object | | | D0 | | | | | |
| S1 | First | 8.092 | 1.300 | 1.5349 | 55.74 | 38.0026 | 4.000 | First |
| S2 | Lens | 12.654 | 2.046 | | | | 3.687 | Lens |
| | | | | | | | | Group |
| S3 | Prism | Infinity | 2.250 | 1.7847 | 25.72 | | 3.460 | |
| S4 | | Infinity | 2.250 | 1.7847 | 25.72 | | 3.221 | |
| S5 | | Infinity | D1 | | | | 2.983 | |
| S6 | Second | −8.912 | 1.500 | 1.8042 | 46.50 | 38.3634 | 2.455 | Second |
| S7 | Lens | −7.443 | 0.100 | | | | 2.506 | Lens |
| S8 | Third | −24.195 | 1.500 | 1.9460 | 17.94 | 20.8044 | 2.406 | Group |
| S9 | Lens | −11.262 | 1.000 | | | | 2.311 | |
| S10 | Fourth | −2.460 | 0.500 | 1.6349 | 23.96 | −5.1306 | 2.137 | |
| S11 | Lens | −10.539 | 0.100 | | | | 2.192 | |
| S12 | Aperture | Infinity | 1.610 | | | | 2.200 | |
| S13 | Fifth | 7.110 | 2.000 | 1.5349 | 55.74 | 7.5967 | 2.946 | |
| S14 | Lens | −8.636 | D2 | | | | 3.146 | |
| S15 | Filter | Infinity | 0.210 | 1.5168 | 64.20 | | 3.546 | |
| S16 | | Infinity | D3 | | | | 3.549 | |
| S17 | Imaging | Infinity | 0.000 | | | | | |
| | Plane | | | | | | | |

TABLE 14

| | Object at Near |
|---|---|
| Object at Infinity | Focus Position |

| | | | |
|---|---|---|---|
| D0 | Infinity | D0 | 300 |
| D1 | 3.55859102 | D1 | 2.15841825 |
| D2 | 13.60634619 | D2 | 15.00651896 |
| D3 | 1 | D3 | 1 |
| f | 18.61005653 | MAG | 0.06006081 |
| FOV | 11.00193557 | FOV | 10.82884962 |
| Fno | 3.15417856 | Fno | 3.38866785 |
| L | 34.531 | L | 34.531 |

In Table 14 above, D0 is the object distance, i.e., the distance on the optical axis from the object to the object-side surface of the first lens 510, D1 is the distance on the optical axis between the reflective member P and the second lens 520, D2 is the distance on the optical axis between the fifth lens 550 and the filter 580, and D3 is the distance on the optical axis between the filter 580 and the imaging plane 590.

Moreover, f is the total focal length of the optical imaging system, MAG is the magnification of the optical imaging system, FOV is the half angle of view of the optical imaging system, Fno is the f-number of the optical imaging system, and L is the distance on the optical axis from the object-side surface of the first lens 510 to the imaging plane 590. Magnification may refer to the ratio of the size of the image to the size of the object.

In the fifth embodiment, the first lens group G1 has a positive refractive power overall, and the second lens group G2 has a positive refractive power overall.

The focal length fG1 of the first lens group G1 is 38.0026 mm, and the focal length fG2 of the second lens group G2 is 18.335 mm.

The effective radius of the object-side surface of the first lens 510 of the first lens group G1 is larger than the effective radius of the image-side surface. The effective radius of the object-side surface of the first lens 510 is 4.000 mm.

In the second lens group G2, the effective radius of the image-side surface of the fifth lens 550 is the largest. The effective radius of the image-side surface of the fifth lens 550 is 3.146 mm.

The first lens 510 has a positive refractive power, the object-side surface of the first lens 510 is convex in a paraxial region thereof, and the image-side surface of the first lens 510 is concave in a paraxial region thereof.

The second lens 520 has a positive refractive power, the object-side surface of the second lens 520 is concave in a paraxial region thereof, and the image-side surface of the second lens 520 is convex in a paraxial region thereof.

The third lens 530 has a positive refractive power, the object-side surface of the third lens 530 is concave in a paraxial region thereof, and the image-side surface of the third lens 530 is convex in a paraxial region thereof.

The fourth lens 540 has a negative refractive power, the object-side surface of the fourth lens 540 is concave in a paraxial region thereof, and the image-side surface of the fourth lens 540 is convex in a paraxial region thereof.

The fifth lens 550 has a positive refractive power, and the object-side surface and the image-side surface of the fifth lens 550 are convex in paraxial regions thereof.

Each surface of the first lens 510, the fourth lens 540, and the fifth lens 550 has aspherical coefficients as illustrated in Table 15 below. For example, the object-side surface and the image-side surface of each of the first lens 510, the fourth lens 540, and the fifth lens 550 are aspherical.

TABLE 15

| | S1 | S2 | S10 | S11 | S13 | S14 |
|---|---|---|---|---|---|---|
| Conic | 2.33858579 | 8.94788705 | −1.50272093 | −23.01211943 | −13.74538177 | 0.81560975 |
| Constant (K) | | | | | | |
| 4th | −8.42407E−05 | 1.28958E−04 | 5.75220E−03 | 1.21754E−03 | −7.20628E−04 | −9.86391E−05 |
| Coefficient (A) | | | | | | |
| 6th | 1.29191E−05 | 1.97219E−05 | −5.61387E−04 | 2.18508E−04 | −8.24206E−05 | −3.58354E−05 |
| Coefficient (B) | | | | | | |
| 8th | −5.40101E−07 | 5.40994E−07 | 5.60178E−05 | −4.13716E−05 | 1.14595E−05 | −1.81119E−06 |
| Coefficient (C) | | | | | | |
| 10th | 2.23611E−08 | −7.20853E−08 | −5.34574E−06 | 4.71275E−06 | −1.08455E−06 | 2.19316E−07 |
| Coefficient (D) | | | | | | |
| 12th | 6.84576E−11 | 5.32945E−09 | 2.63262E−07 | −2.56190E−07 | 2.07398E−08 | −2.29195E−08 |
| Coefficient (E) | | | | | | |

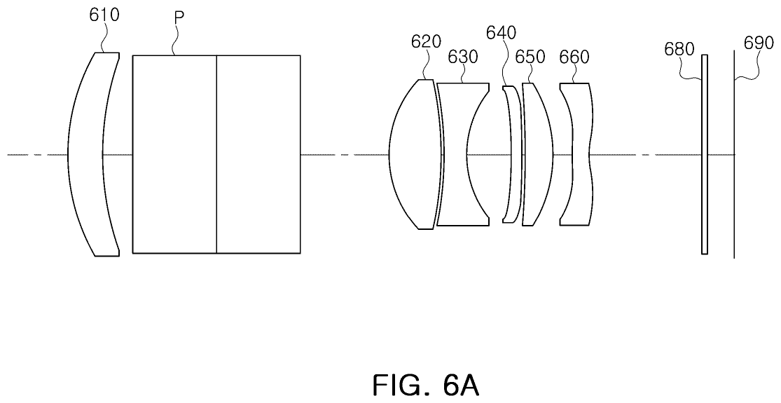

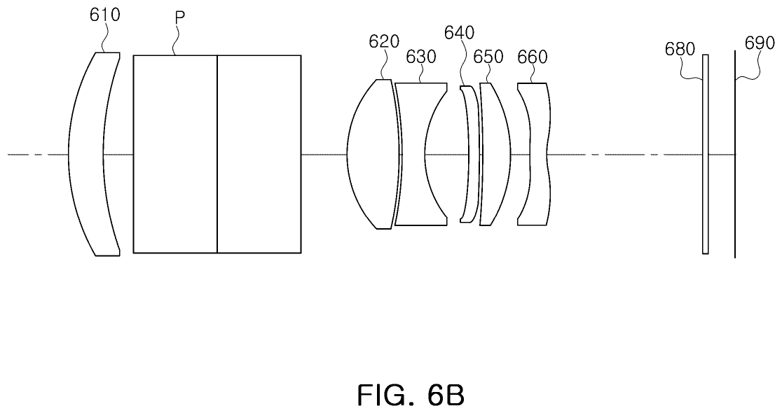

FIG. 6A is a configuration diagram of an optical imaging system according to a sixth embodiment when shooting an object at an infinite distance, and FIG. 6B is a configuration diagram of the optical imaging system according to the sixth embodiment when shooting an object at a near-focus position, i.e., a nearest position of an object at which the optical imaging system can focus an image of the object.

The optical imaging system according to the sixth embodiment will be described with reference to FIGS. 6A and 6B.

The optical imaging system according to the sixth embodiment includes a first lens group G1 and a second lens group G2. Moreover, the optical imaging system includes a reflective member P disposed in front of the second lens group G2.

In order from the object side, the first lens group G1 includes a first lens 610, and the second lens group G2 includes a second lens 620, a third lens 630, a fourth lens 640, a fifth lens 650, and a sixth lens 660.

The first lens group G1 may further include a reflective member P disposed between the first lens 610 and the second lens 620. An aperture may be disposed between the reflective member P and the second lens 620.

The first lens 610 to the sixth lens 660 are made of a plastic material.

Additionally, the optical imaging system may further include a filter 680 and an image sensor.

The optical imaging system according to the sixth embodiment may form a focus on an imaging plane 690. The imaging plane 690 may refer to a surface on which a focus is formed by the optical imaging system. As an example, the imaging plane 690 may refer to one surface of the image sensor receiving light.

In the sixth embodiment, the reflective member P may be a prism, but alternatively may be a mirror.

The first lens group G1 is fixedly disposed, and the second lens group G2 may be moved along the optical axis for focus adjustment.

The characteristics of each lens (a radius of curvature, a thickness of the lens or a distance between lenses, a refractive index, an Abbe number, a focal length, and an effective radius) are illustrated in Table 16 below.

TABLE 16

| Surface | | Radius of | Thickness/ | Refractive | Abbe | Focal | Effective | Lens |
|---|---|---|---|---|---|---|---|---|
| No. | Element | Curvature | Distance | Index | Number | Length | Radius | Group |
| Object | | | D0 | | | | | |
| S1 | First | 9.041 | 1.300 | 1.5366 | 55.74 | 44.8928 | 3.860 | First |
| S2 | Lens | 13.746 | 1.150 | | | | 3.636 | Lens |
| | | | | | | | | Group |
| S3 | Prism | Infinity | 3.200 | 1.9308 | 20.88 | | 3.579 | |
| S4 | | Infinity | 3.200 | 1.9308 | 20.88 | | 3.404 | |
| S5 | | Infinity | D1 | | | | 3.236 | |
| S6 | Second | 4.109 | 1.980 | 1.5366 | 55.74 | 5.8951 | 2.830 | Second |
| S7 | Lens | −11.432 | 0.100 | | | | 2.742 | Lens |
| S8 | Third | −11.616 | 0.900 | 1.6187 | 25.94 | −4.8495 | 2.700 | Group |
| S9 | Lens | 4.165 | 1.681 | | | | 2.400 | |
| S10 | Fourth | −41.234 | 0.400 | 1.5458 | 55.99 | 141.2366 | 2.438 | |
| S11 | Lens | −26.956 | 0.108 | | | | 2.589 | |
| S12 | Fifth | −17.051 | 1.070 | 1.6665 | 20.38 | 7.8471 | 2.652 | |
| S13 | Lens | −4.103 | 0.753 | | | | 2.686 | |
| S14 | Sixth | −44.177 | 0.660 | 1.6440 | 23.49 | −8.8988 | 2.474 | |
| S15 | Lens | 6.624 | D2 | | | | 2.700 | |
| S16 | Filter | Infinity | 0.210 | 1.5183 | 64.20 | | 3.741 | |
| S17 | | Infinity | D3 | | | | 3.765 | |
| S18 | Imaging | Infinity | −0.005 | | | | | |
| | Plane | | | | | | | |

TABLE 17

| | Object at Near |
|---|---|
| Object at Infinity | Focus Position |

| | | | |
|---|---|---|---|
| D0 | infinity | D0 | 200 |
| D1 | 3.299481 | D1 | 1.66652193 |
| D2 | 4.24351858 | D2 | 5.87647765 |
| D3 | 1 | D3 | 1 |
| f | 16.56545201 | MAG | 0.08766419 |
| FOV | 13.06479281 | FOV | 11.83866115 |
| Fno | 2.20248287 | Fno | 2.57581034 |
| L | 25.25 | L | 25.25 |

In Table 17 above, D0 is the object distance, i.e., the distance on the optical axis from the object to the object-side surface of the first lens 610, D1 is the distance on the optical axis between the reflective member P and the second lens 620, D2 is the distance on the optical axis between the sixth lens 660 and the filter 680, and D3 is the distance on the optical axis between the filter 680 and the imaging plane 690.

Moreover, f is the total focal length of the optical imaging system, MAG is the magnification of the optical imaging system, FOV is the half angle of view of the optical imaging system, Fno is the f-number of the optical imaging system, and L is the distance on the optical axis from the object-side surface of the first lens 610 to the imaging plane 690. Magnification may refer to the ratio of the size of the image to the size of the object.

In the sixth embodiment, the first lens group G1 has a positive refractive power overall, and the second lens group G2 has a positive refractive power overall.

The focal length fG1 of the first lens group G1 is 44.8928 mm, and the focal length fG2 of the second lens group G2 is 23.662 mm.

The effective radius of the object-side surface of the first lens 610 of the first lens group G1 is larger than the effective radius of the image-side surface. The effective radius of the object-side surface of the first lens 610 is 3.860 mm.

In the second lens group G2, the effective radius of the object-side surface of the second lens 620 is the largest. The effective radius of the object-side surface of the second lens 620 is 2.830 mm.

The first lens 610 has a positive refractive power, the object-side surface of the first lens 610 is convex in a paraxial region thereof, and the image-side surface of the first lens 610 is concave in a paraxial region thereof.

The second lens 620 has a positive refractive power, and the object-side surface and the image-side surface of the second lens 620 are convex in paraxial regions thereof.

The third lens 630 has a negative refractive power, and the object-side surface and the image-side surface of the third lens 630 are concave in paraxial regions thereof.

The fourth lens 640 has a positive refractive power, the object-side surface of the fourth lens 640 is concave, in a paraxial region thereof and the image-side surface of the fourth lens 640 is convex in a paraxial region thereof.

The fifth lens 650 has a positive refractive power, the object-side surface of the fifth lens 650 is concave in a paraxial region thereof, and the image-side surface of the fifth lens 650 is convex in a paraxial region thereof.

The sixth lens 660 has a negative refractive power, and the object-side surface and the image-side surface of the sixth lens 660 are concave in paraxial regions thereof.

Each surface of the first to sixth lenses 610 to 660 has aspheric coefficients as illustrated in Table 18 below. For example, the object-side surface and the image-side surface of each of the first to sixth lenses 610 to 660 are aspherical.

TABLE 18

| | S1 | S2 | S6 | S7 | S8 | S9 |
|---|---|---|---|---|---|---|
| Conic | −8.629689 | 5.009359 | 0.7947941 | −0.03371783 | 3.415846 | −0.931217 |
| Constant (K) | | | | | | |
| 4th | 2.51407E−03 | 1.19402E−03 | −8.82232E−04 | 6.01010E−03 | −3.43210E−04 | −3.76343E−03 |
| Coefficient (A) | | | | | | |
| 6th | −4.06854E−04 | −5.35020E−04 | 4.09814E−04 | −1.25187E−03 | 1.95491E−04 | 3.07680E−04 |
| Coefficient (B) | | | | | | |
| 8th | 1.07127E−04 | 1.83918E−04 | −6.22178E−04 | 2.16262E−04 | 2.29816E−05 | 8.60155E−04 |
| Coefficient (C) | | | | | | |
| 10th | −1.88715E−05 | −4.00418E−05 | 3.56953E−04 | −4.93243E−05 | −2.32352E−06 | −1.73582E−04 |
| Coefficient (D) | | | | | | |
| 12th | 2.21785E−06 | 5.83804E−06 | −1.21263E−04 | 1.40481E−05 | 0.00000E+00 | −1.17008E−04 |
| Coefficient (E) | | | | | | |

| | S10 | S11 | S12 | S13 | S14 | S15 |
|---|---|---|---|---|---|---|
| Conic | −98.990098 | 79.002637 | −62.126929 | −1.892385 | −0.00001534 | −1.744198 |
| Constant (K) | | | | | | |
| 4th | −2.96645E−03 | 4.05928E−03 | 6.51251E−03 | 8.10786E−03 | −3.00760E−03 | −1.34850E−02 |
| Coefficient (A) | | | | | | |
| 6th | −6.88407E−06 | −6.93222E−05 | 9.62771E−04 | 8.16744E−04 | −3.65327E−03 | −1.09758E−03 |
| Coefficient (B) | | | | | | |
| 8th | 1.93197E−04 | −1.54861E−04 | −1.53013E−03 | −2.56010E−03 | 1.03795E−03 | 8.84358E−04 |
| Coefficient (C) | | | | | | |
| 10th | −5.09551E−05 | −1.41845E−05 | 4.28736E−04 | 1.10995E−03 | −7.53409E−04 | −4.04260E−04 |
| Coefficient (D) | | | | | | |
| 12th | −3.83443E−06 | 1.17440E−06 | −5.74438E−05 | −2.60917E−04 | 4.34819E−04 | 1.49267E−04 |
| Coefficient (E) | | | | | | |

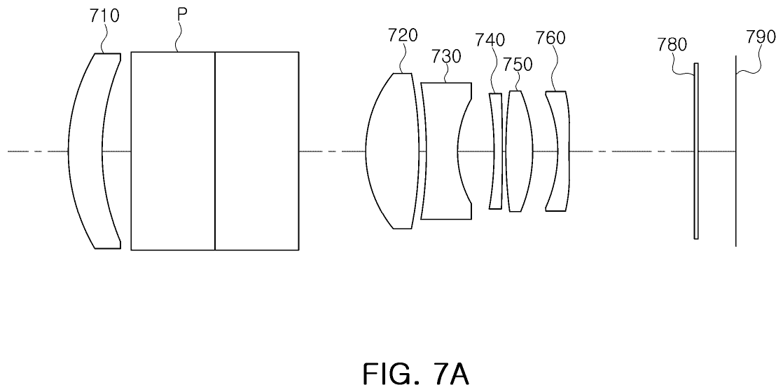

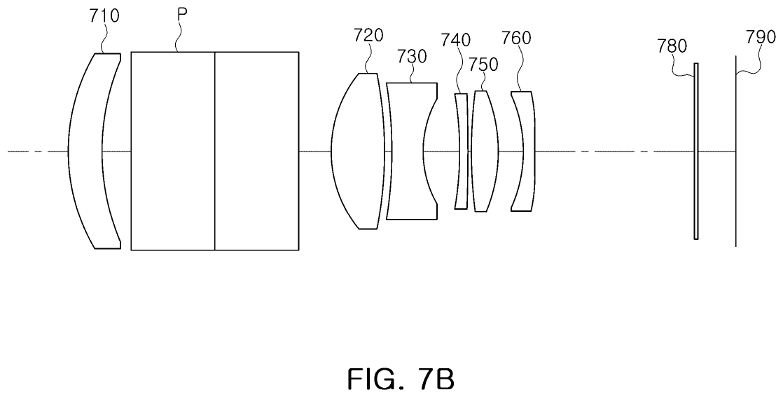

FIG. 7A is a configuration diagram of an optical imaging system according to a seventh embodiment when shooting an object at an infinite distance, and FIG. 7B is a configuration diagram of the optical imaging system according to the seventh embodiment when shooting an object at a near-focus position, i.e., a nearest position of an object at which the optical imaging system can focus an image of the object.

The optical imaging system according to the seventh embodiment will be described with reference to FIGS. 7A and 7B.

The optical imaging system according to the seventh embodiment includes a first lens group G1 and a second lens group G2. Moreover, the optical imaging system includes a reflective member P disposed in front of the second lens group G2.

In order from the object side, the first lens group G1 includes a first lens 710, and the second lens group G2 includes a second lens 720, a third lens 730, a fourth lens 740, a fifth lens 750, and a sixth lens 760.

The first lens group G1 may further include a reflective member P disposed between the first lens 710 and the second lens 720. An aperture may be disposed between the third lens 730 and the fourth lens 740.

The first lens 710 to the sixth lens 760 are made of a plastic material.

Additionally, the optical imaging system may further include a filter 780 and an image sensor.

The optical imaging system according to the seventh embodiment may form a focus on an imaging plane 790. The imaging plane 790 may refer to a surface on which a focus is formed by the optical imaging system. As an example, the imaging plane 790 may refer to one surface of the image sensor receiving light.

In the seventh embodiment, the reflective member P may be a prism, but alternatively may be a mirror.

The first lens group G1 is fixedly disposed, and the second lens group G2 may be moved along the optical axis for focus adjustment.

The characteristics of each lens (a radius of curvature, a thickness of the lens or a distance between lenses, a refractive index, an Abbe number, a focal length, and an effective radius) are illustrated in Table 19 below.

TABLE 19

| Surface | | Radius of | Thickness/ | Refractive | Abbe | Focal | Effective | Lens |
|---|---|---|---|---|---|---|---|---|
| No. | Element | Curvature | Distance | Index | Number | Length | Radius | Group |
| Object | | | D0 | | | | | |
| S1 | First | 7.987 | 1.300 | 1.5366 | 55.74 | 44.3000 | 3.600 | First |
| S2 | Lens | 11.344 | 1.020 | | | | 3.373 | Lens |
| | | | | | | | | Group |
| S3 | Prism | Infinity | 3.100 | 1.7217 | 29.50 | | 3.343 | |
| S4 | | Infinity | 3.100 | 1.7217 | 29.50 | | 3.195 | |
| S5 | | Infinity | D1 | | | | 3.047 | |
| S6 | Second | 4.407 | 1.986 | 1.5366 | 55.74 | 6.2731 | 2.868 | Second |
| S7 | Lens | −12.010 | 0.252 | | | | 2.677 | Lens |
| S8 | Third | −12.504 | 1.174 | 1.6440 | 23.49 | −4.5297 | 2.517 | Group |
| S9 | Lens | 3.945 | 1.330 | | | | 1.952 | |
| S10 | Fourth | −20.543 | 0.339 | 1.5458 | 55.99 | −67.4772 | 2.038 | |
| S11 | Lens | −46.7272 | 0.131 | | | | 2.125 | |
| S12 | Fifth | 72.354 | 0.991 | 1.6665 | 20.38 | 6.7945 | 2.184 | |
| S13 | Lens | −4.805 | 0.914 | | | | 2.217 | |
| S14 | Sixth | −7.674 | 0.433 | 1.6440 | 23.49 | −10.2418 | 2.091 | |
| S15 | Lens | 48.000 | D2 | | | | 2.200 | |
| S16 | Filter | Infinity | 0.110 | 1.5183 | 64.20 | | 3.257 | |
| S17 | | Infinity | D3 | | | | 3.270 | |
| S18 | Imaging | Infinity | 0.01 | | | | | |
| | Plane | | | | | | | |

TABLE 20

| | Object at Near |
|---|---|
| Object at Infinity | Focus Position |

| | | | |
|---|---|---|---|
| D0 | Infinity | D0 | 300 |
| D1 | 2.56 | D1 | 1.25392197 |
| D2 | 4.66943014 | D2 | 5.97550817 |
| D3 | 1.41 | D3 | 1.41 |
| f | 17.90658264 | MAG | 0.0623942 |
| FOV | 11.01087494 | FOV | 9.9450653 |
| Fno | 2.48702537 | Fno | 2.60588436 |
| L | 24.82943014 | L | 24.82943014 |

In Table 20 above, D0 is the object distance, i.e., the distance on the optical axis from the object to the object-side surface of the first lens 710, D1 is the distance on the optical axis between the reflective member P and the second lens 720, D2 is the distance on the optical axis between the sixth lens 760 and the filter 780, and D3 is the distance on the optical axis between the filter 780 and the imaging plane 790.

Moreover, f is the total focal length of the optical imaging system, MAG is the magnification of the optical imaging system, FOV is the half angle of view of the optical imaging system, Fno is the f-number of the optical imaging system, and L is the distance on the optical axis from the object-side surface of the first lens 710 to the imaging plane 790. Magnification may refer to the ratio of the size of the image to the size of the object.

In the seventh embodiment, the first lens group G1 has a positive refractive power overall, and the second lens group G2 has a positive refractive power overall.

The focal length fG1 of the first lens group G1 is 44.3000 mm, and the focal length fG2 of the second lens group G2 is 28.046 mm.

The effective radius of the object-side surface of the first lens 710 of the first lens group G1 is larger than the effective radius of the image-side surface of the first lens 710. The effective radius of the object-side surface of the first lens 710 is 3.600 mm.

In the second lens group G2, the effective radius of the object-side surface of the second lens 720 is the largest. The effective radius of the object-side surface of the second lens 720 is 2.868 mm.

The first lens 710 has a positive refractive power, the object-side surface of the first lens 710 is convex in a paraxial region thereof, and the image-side surface of the first lens 710 is concave in a paraxial region thereof.

The second lens 720 has a positive refractive power, and the object-side surface and the image-side surface of the second lens 720 are convex in paraxial regions thereof.

The third lens 730 has a negative refractive power, and the object-side surface and the image-side surface of the third lens 730 are concave in paraxial regions thereof.

The fourth lens 740 has a negative refractive power, the object-side surface of the fourth lens 740 is concave in a paraxial region thereof, and the image-side surface of the fourth lens 740 is convex in a paraxial region thereof.

The fifth lens 750 has a positive refractive power, and the object-side surface and the image-side surface of the fifth lens 750 are convex in paraxial regions thereof.

The sixth lens 760 has a negative refractive power, and the object-side surface and the image-side surface of the sixth lens 760 are concave in paraxial regions thereof.

Each surface of the first to sixth lenses 710 to 760 has aspheric coefficients as illustrated in Table 21 below. For example, the object-side surface and the image-side surface of each of the first to sixth lenses 710 to 760 are aspherical.

TABLE 21

| | S1 | S2 | S6 | S7 | S8 | S9 |
|---|---|---|---|---|---|---|
| Conic | −5.8572 | 4.8792 | 0 | 0.03707 | 5.00122 | −1.15852 |
| Constant (K) | | | | | | |
| 4th | 9.62929E−04 | −6.62822E−04 | 3.08052E−04 | 2.58163E−03 | −3.18964E−04 | −1.51550E−03 |
| Coefficient (A) | | | | | | |
| 6th | 5.01281E−04 | 5.86667E−04 | 1.14997E−05 | 3.77575E−04 | 2.29559E−05 | 7.97627E−04 |
| Coefficient (B) | | | | | | |
| 8th | −1.67439E−04 | −1.90164E−04 | −2.69904E−06 | −7.99026E−04 | 1.37833E−05 | −2.24035E−05 |
| Coefficient (C) | | | | | | |
| 10th | 3.35992E−05 | 3.72543E−05 | −1.61322E−06 | 4.64785E−04 | 3.44714E−06 | −1.43755E−04 |
| Coefficient (D) | | | | | | |
| 12th | −4.24414E−06 | −4.34975E−06 | | −1.66976E−04 | | 1.70628E−04 |
| Coefficient (E) | | | | | | |

| | S10 | S11 | S12 | S13 | S14 | S15 |
|---|---|---|---|---|---|---|
| Conic | 24.53385 | 42.24757 | 15.10362 | −1.73311 | 0 | 0 |
| Constant (K) | | | | | | |
| 4th | −2.52225E−03 | 2.90026E−03 | 8.45534E−03 | 6.02197E−03 | −4.11230E−03 | −9.12242E−03 |
| Coefficient (A) | | | | | | |
| 6th | 4.00213E−04 | 1.65600E−04 | −2.37557E−04 | 1.36816E−04 | −8.64600E−04 | 1.34820E−04 |
| Coefficient (B) | | | | | | |
| 8th | 1.28631E−04 | −7.79889E−05 | −4.14371E−04 | −7.08155E−04 | −8.78384E−05 | −1.27863E−05 |
| Coefficient (C) | | | | | | |
| 10th | −4.44990E−05 | −1.73813E−05 | 8.31381E−05 | 2.43893E−04 | 1.99678E−05 | 5.25319E−06 |
| Coefficient (D) | | | | | | |
| 12th | −2.40988E−06 | | −7.72987E−06 | −5.79410E−05 | 5.16642E−07 | |
| Coefficient (E) | | | | | | |

Table 22 below lists the values of D11P, D12P, DP21, DR, D2, L2S1_ED, RG1_S1, RG1_S2, RG2_S1, fG1, fG2, Lf, Lr, G1_MED, G2_MED, and PED in Conditional Expressions 1 to 21. The values of DP21 are the values when the second lens group G2 is in the position closest to the imaging plane when the optical imaging system is shooting an object at an infinite distance as shown in FIGS. 1A, 2A, 3A, 4A, 5A, 6A, and 7A.

TABLE 22

| | First | Second | Third | Fourth | Fifth | Sixth | Seventh |
|---|---|---|---|---|---|---|---|
| | Embodiment | Embodiment | Embodiment | Embodiment | Embodiment | Embodiment | Embodiment |
| D11P | 3.346 | 3.346 | 2.450 | 2.320 | 3.346 | 2.450 | 2.320 |
| D12P | 2.046 | 2.046 | 1.150 | 1.020 | 2.046 | 1.150 | 1.020 |
| DP21 | 3.560 | 3.560 | 2.501 | 2.684 | 3.559 | 3.299 | 2.560 |
| DR | 2.250 | 2.250 | 3.200 | 3.100 | 2.250 | 3.200 | 3.100 |
| D2 | 5.184 | 11.081 | 11.731 | 10.674 | 8.310 | 7.652 | 7.550 |
| L2S1_ED | 4.120 | 4.792 | 6.600 | 5.744 | 4.910 | 5.660 | 5.736 |
| RG1_S1 | 8.092 | 8.092 | 9.041 | 7.987 | 8.092 | 9.041 | 7.987 |
| RG1_S2 | 12.654 | 12.654 | 13.746 | 11.344 | 12.654 | 13.746 | 11.344 |
| RG2_S1 | 3.393 | 34.792 | 8.103 | 9.010 | −8.912 | 4.109 | 4.407 |
| fG1 | 38.0026 | 38.0026 | 44.8451 | 44.2579 | 38.0026 | 44.8928 | 44.3000 |
| fG2 | 27.169 | 17.181 | 15.162 | 18.335 | 18.335 | 23.662 | 28.046 |
| Lf | 5.596 | 5.596 | 5.650 | 5.420 | 5.596 | 5.650 | 5.420 |
| Lr | 19.948 | 25.800 | 23.019 | 22.036 | 28.935 | 19.600 | 19.409 |
| G1_MED | 6.960 | 8.000 | 9.000 | 9.038 | 8.000 | 7.720 | 7.200 |
| G2_MED | 4.120 | 6.730 | 7.200 | 7.432 | 6.292 | 5.660 | 5.736 |
| PED | 5.920 | 6.972 | 8.450 | 8.402 | 6.920 | 7.158 | 6.686 |

As set forth above, with an optical imaging system according to an embodiment, the size of the optical imaging system may be reduced and high-resolution images may be captured.

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens group comprising a reflective member and one or two lenses disposed in front of the reflective member; and
a second lens group disposed behind the reflective member and comprising a plurality of lenses,
wherein the one or two lenses included in the first lens group have a positive refractive power overall,
an image-side surface of a lens disposed closest to the reflective member among the one or two lenses of the first lens group is concave,
the reflective member comprises an incident surface, a reflection surface, and an exit surface, and
0.25≤D12P/DR≤1.0 is satisfied, where D12P is a distance on an optical axis of the optical imaging system from the image-side surface of the lens disposed closest to the reflective member among the one or two lenses of the first lens group to the incident surface of the reflective member, and DR is a distance on the optical axis from the incident surface of the reflective member to the reflection surface of the reflective member.

2. The optical imaging system of claim 1, wherein the reflective member is configured to be rotatable about two axes perpendicular to each other.

3. The optical imaging system of claim 1, wherein the one or two lenses included in the first lens group comprise a first lens having an object-side surface that is convex in a paraxial region thereof, and an image-side surface that is concave in a paraxial region thereof, and
an effective diameter of the object-side surface of the first lens and an effective diameter of the image-side surface of the first lens are greater than a minor axis length of the incident surface of the reflective member.

4. The optical imaging system of claim 3, wherein 0.6<RG1_S1/RG1_S2<0.8 is satisfied, where RG1_S1 is a radius of curvature of the object-side surface of the first lens, and RG1_S2 is a radius of curvature of the image-side surface of the first lens.

5. The optical imaging system of claim 1, wherein 1.3<fG1/fG2<3 is satisfied, where fG1 is a focal length of the first lens group, and fG2 is a focal length of the second lens group.

6. The optical imaging system of claim 1, wherein 0.35≤DR/L2S1_ED≤0.65 is satisfied, where L2S1_ED is an effective diameter of an object-side surface of a lens disposed closest to the reflective member among the plurality of lenses included in the second lens group.

7. The optical imaging system of claim 1, wherein 0.65≤D11P/DR≤1.55 is satisfied, where D11P is a distance on the optical axis from an object-side surface of a lens disposed closest to an object side of the optical imaging system among the one or two lenses included in the first lens group to the incident surface of the reflective member.

8. The optical imaging system of claim 1, wherein −0.25≤(RG1_S1-RG1_S2)/(RG1_S1+RG1_S2)<0 is satisfied, where RG1_S1 is a radius of curvature of an object-side surface of a lens disposed closest to an object side of the optical imaging system among the one or two lenses included in the first lens group, and RG1_S2 is a radius of curvature of the image-side surface of the lens disposed closest to the reflective member among the one or two lenses included in the first lens group.

9. The optical imaging system of claim 1, wherein −0.6≤RG2_S1/fG2≤2.1 is satisfied, where RG2_S1 is a radius of curvature of an object-side surface of a lens disposed closest to the reflective member among the plurality of lenses included in the second lens group, and fG2 is a focal length of the second lens group.

10. The optical imaging system of claim 1, wherein 0.7≤DP21/DR≤1.6 is satisfied, where DP21 is a distance on the optical axis from the exit surface of the reflective member to an object-side surface of a lens disposed closest to the reflective member among the plurality of lenses included in the second lens group.

11. The optical imaging system of claim 10, wherein 0<D12P/L<0.1, 0<DP21/L≤0.2, and 0.3<D12P/DP21<0.6 are satisfied, where L is a sum of a distance on the optical axis from an object-side surface of a lens disposed closest to an object side of the optical imaging system among the one or two lenses included in the first lens group to the reflection surface of the reflective member, and a distance on the optical axis from the reflection surface of the reflective member to an imaging plane of the optical imaging system.

12. The optical imaging system of claim 1, wherein 1.1≤fG1/L≤1.9 is satisfied, where fG1 is a focal length of the first lens group, and L is a sum of a distance on the optical axis from an object-side surface of a lens disposed closest to an object side of the optical imaging system among the one or two lenses included in the first lens group to the reflection surface of the reflective member, and a distance on the optical axis from the reflection surface of the reflective member to an imaging plane of the optical imaging system.

13. The optical imaging system of claim 1, wherein 0.1≤Lf/Lr≤0.4 is satisfied, where Lf is a distance on the optical axis from an object-side surface of a lens disposed closest to an object side of the optical imaging system among the one or two lenses included in the first lens group to the reflection surface of the reflective member, and Lr is a distance on the optical axis from the reflection surface of the reflective member to an imaging plane of the optical imaging system.

14. The optical imaging system of claim 1, wherein 0.25<G1_MED/Lr<0.42 and 0.7<G2_MED/Lf<1.4 are satisfied, where G1_MED is a maximum effective diameter of the one or two lenses included in the first lens group, and G2_MED is a maximum effective diameter of the plurality of lenses included in the second lens group.

15. The optical imaging system of claim 1, wherein 0.35<f/fG1≤0.5 is satisfied, where f is a total focal length of the optical imaging system, and fG1 is a focal length of the first lens group.

16. The optical imaging system of claim 1, wherein 0.6<f/fG2≤1.1 is satisfied, where f is a total focal length of the optical imaging system, and fG2 is a focal length of the second lens group.

17. The optical imaging system of claim 1, wherein a lens disposed closest to the reflective member among the plurality of lenses of the second lens group has a positive refractive power.

18. The optical imaging system of claim 1, wherein at least three lenses among the plurality of lenses of the second lens group have a refractive index greater than 1.6.

19. An optical imaging system comprising:
a first lens group comprising a reflective member and one or two lenses disposed in front of the reflective member; and
a second lens group disposed behind the reflective member and comprising a plurality of lenses,
wherein the one or two lenses of the first lens group have a positive refractive power overall,
an image-side surface of a lens disposed closest to the reflective member among the one or two lenses of the first lens group is concave,
the reflective member comprises an incident surface, a reflection surface, and an exit surface, and
0.7≤DP21/DR≤1.6 is satisfied, where DP21 is a distance on an optical axis of the optical imaging system from the exit surface of the reflective member to an object-side surface of a lens disposed closest to the reflective member among the lenses of the second lens group, and DR is a distance on the optical axis from the incident surface of the reflective member to the reflection surface of the reflective member.

20. The optical imaging system of claim 19, wherein there are a total of one lens having a refractive power in the first lens group, and a total of five or six lenses having a refractive power in the second lens group.

21. The optical imaging system of claim 20, wherein the one lens of the first lens group is a first lens having a positive refractive power, a convex object-side surface in a paraxial region thereof, and a concave image-side surface in a paraxial region thereof, and
the five or six lenses of the second lens group comprise a second lens closest to the reflective member among the five or six lenses of the second lens group and having a positive refractive power.

22. The optical imaging system of claim 21, wherein there is a total of five lenses having a refractive power in the second lens group, and
the five lenses comprise the second lens having the positive refractive power, a third lens having a negative refractive power, a fourth lens having a positive refractive power or a negative refractive power, a fifth lens having a positive refractive power, and a sixth lens having a positive refractive power or a negative refractive power.

23. The optical imaging system of claim 19, wherein the plurality of lenses of the second lens group are configured so that lenses among the plurality of lenses disposed adjacent to each other have different refractive indexes and different Abbe numbers.

24. An optical imaging system comprising:
a first lens group comprising a reflective member and one or two lenses disposed in front of the reflective member; and
a second lens group disposed behind the reflective member and comprising a plurality of lenses,
wherein the one or two lenses of the first lens group have a positive refractive power overall,
an image-side surface of a lens disposed closest to the reflective member among the one or two lenses of the first lens group is concave,
the reflective member comprises an incident surface, a reflection surface, and an exit surface, and
0.3<D12P/DP21<0.6 is satisfied, where D12P is a distance on an optical axis of the optical imaging system from the image-side surface of the lens disposed closest to the reflective member among the one or two lenses of the first lens group to the incident surface of the reflective member, and DP21 is a distance on the optical axis from the exit surface of the reflective member to an object-side surface of a lens disposed closest to the reflective member among the plurality of lenses of the second lens group.

25. The optical imaging system of claim 24, wherein there are a total of one lens having a refractive power in the first lens group, and a total of five or six lenses having a refractive power in the second lens group.

26. The optical imaging system of claim 25, wherein the one lens of the first lens group is a first lens having a positive refractive power, a convex object-side surface in a paraxial region thereof, and a concave image-side surface in a paraxial region thereof, and
the five or six lenses of the second lens group comprise a second lens closest to the reflective member among the five or six lenses of the second lens group and having a positive refractive power.

27. The optical imaging system of claim 26, wherein there is a total of six lenses having a refractive power in the second lens group, and
the six lenses comprise the second lens having the positive refractive power, a third lens having a positive refractive power, a fourth lens having a negative refractive power, a fifth lens having a negative refractive power, a sixth lens having a positive refractive power, and a seventh lens having a positive refractive power or a negative refractive power.

28. The optical imaging system of claim 24, wherein the first lens group is disposed at a fixed position on the optical axis, and
the second lens groups is configured to be movable along the optical axis relative to the first lens group to adjust a focus of the optical imaging system.
